(19) United States
(12) Patent Application Publication
(10) Pub. No.: US 2014/0173648 A1
(43) Pub. Date: Jun. 19, 2014

(54) INTERACTIVE CELEBRITY PORTAL BROADCAST SYSTEMS AND METHODS

(71) Applicant: THE TALENT CHANNELS JV OPERATING CO LIMITED, London (GB)

(72) Inventors: Julian Ball, London (GB); Simon Johnson, London (GB); Adrian Woolfe, London (GB)

(21) Appl. No.: 13/715,948

(22) Filed: Dec. 14, 2012

(51) Int. Cl. H04N 21/472

(52) U.S. Cl. CPC H04N 21/47211
USPC 725/25; 725/104

(57) ABSTRACT

A celebrity portal system is disclosed. The celebrity portal system may comprise a celebrity content management engine for managing a celebrity portal, the celebrity portal including media content based on real-time multimedia content generated by a particular celebrity and available for consumption by fans; a broadcast information engine for receiving notice of a scheduled presentation of premium content on the celebrity portal; a fan contact engine for notifying a set of the fans of the scheduled presentation of the premium content on the celebrity portal; and a content publication engine for publishing the premium content in the celebrity portal.

### CROSS-REFERENCE

This application incorporates by reference the following patent applications: U.S. Ser. No. 13/715,806, filed Dec. 14, 2012, entitled “Interactive Celebrity Portal and Methods;” and U.S. Ser. No. 13/715,923, filed Dec. 14, 2012, entitled “Real-Time Presentation of Fan-Generated Content.”

### TECHNICAL FIELD

The technical field relates to computer systems and methods. More particularly, the technical field relates to digital media systems and methods.

### BACKGROUND

Broadcast television has long served as the medium of choice for people who desire a rich entertainment experience. With broadcast television, a group of television stations transmit picture, sound, and video to viewers using terrestrial or satellite transmission systems. Viewers tune into the television broadcasts using antennas or cable boxes on their televisions. A few major content producers, such as the television studios in a given market, traditionally dominated the programming of television broadcasts. The production and transmission of a television broadcast comes at a high cost and focuses on mass markets. The high costs also required studios to pre-package content and perform live broadcasts only sparingly. Additionally, as a pure broadcast medium, broadcast television offered viewers with few opportunities to interact with programmed content.

Networked device, such as wireless phones with a wireless network connection, tablet devices, computers, and networked set-top boxes, allow viewers to access content through communication channels other than the airwaves or cable lines. For instance, networked devices are often configured with an interface to allow viewers to access content, such as multimedia content and social media, over the Internet. Networked devices may increase the number of content producers that can access a given viewer. However, the amount of information available to a user of a networked device may be overwhelming and disorganized. As a result, programming for networked devices often appears underproduced when compared to media such as broadcast television. Content programmed for a networked device therefore runs the risk of appearing cheaply produced and poorly branded. Consequently, it is typically difficult to attract name-brand talent to this content distribution medium.

### SUMMARY

A celebrity portal system may comprise: a celebrity content management engine for managing a celebrity portal, the celebrity portal including media content based on real-time multimedia content generated by a particular celebrity and available for consumption by fans; a broadcast information engine for receiving notice of a scheduled presentation of premium content on the celebrity portal; a fan contact engine for notifying a set of the fans of the scheduled presentation of the premium content on the celebrity portal; and a content publication engine for publishing the premium content in the celebrity portal.

In some embodiments, the fan contact engine may be configured to notify the set of the fans using multiple contact methods. The premium content may include at least a portion of the real-time multimedia content. The premium content may comprise pay-per-view content.

The celebrity portal system may comprise a timer control engine for providing the set of fans with a timer configured count down to the premium content. In some embodiments, the celebrity portal system may comprise an expiration warning notification engine for providing an expiration notification of the timer a predetermined time before expiration of the timer.

In some embodiments, the celebrity portal system may comprise an access rights engine for selecting at least a portion of the set of fans to view the premium content based on access rights of the least a portion of the set of fans. The access rights engine may be configured to offer the set of fans an option to purchase the premium content. In the celebrity portal system, the celebrity portal may be adapted to be displayed on a mobile device.

A method may comprise: managing a celebrity portal, the celebrity portal including media content based on real-time multimedia content generated by a particular celebrity and available for consumption by fans; receiving notice of a scheduled presentation of premium content on the celebrity portal; notifying a set of the fans of the scheduled presentation of the premium content on the celebrity portal; and publishing the premium content in the celebrity portal.

Notifying the set of the fans may comprise using multiple contact methods. In the method, the premium content may include at least a portion of the real-time multimedia content. The premium content may comprise pay-per-view content.

In some embodiments, the method may comprise providing the set of fans with a timer configured count down to the premium content. The method may include providing an expiration notification of the timer a predetermined time before expiration of the timer.

The method may comprise selecting at least a portion of the set of fans to view the premium content based on access rights of the least a portion of the set of fans. In some embodiments, the method may comprise offering the set of fans an option to purchase the premium content. In the method, the celebrity portal may be adapted to be displayed on a mobile device.

A celebrity portal system may comprise: means for managing a celebrity portal, the celebrity portal including media content based on real-time multimedia content generated by a particular celebrity and available for consumption by fans; means for receiving notice of a scheduled presentation of premium content on the celebrity portal; means for notifying a set of the fans of the scheduled presentation of the premium content on the celebrity portal; and means for publishing the premium content in the celebrity portal.

### BRIEF DESCRIPTION OF THE DRAWINGS

FIG. 1 shows an example of a celebrity portal environment, according to some embodiments.

FIG. 2 shows an example of a production system, according to some embodiments.

FIG. 3 shows an example of a celebrity-content access system, according to some embodiments.

FIG. 4A shows an example of a celebrity portal system, according to some embodiments.

FIG. 4B shows an example of a content enhancement engine for enhancing a special broadcast of premium content, according to some embodiments.

FIG. 5A shows an example of an editor system, according to some embodiments.

FIG. 5B shows an example of an editor system, according to some embodiments.

FIG. 5C shows an example of a content enhancement application programming interface (API) engine, according to some embodiments.

FIG. 6 shows a flowchart of an example of a method for generating celebrity content, according to some embodiments.

FIG. 7 shows a flowchart of an example of a method for accessing a celebrity portal, according to some embodiments.

FIG. 8A shows a flowchart of an example of a method for managing a celebrity portal, according to some embodiments.

FIG. 8B shows a flowchart of an example of a method for gathering enhancements to superimpose on celebrity-generated content.

FIG. 9A shows a flowchart of an example of a method for managing a celebrity portal, according to some embodiments.

FIG. 9B shows a flowchart of an example of a method for accessing enhancing content to superimpose on celebrity-generated content.

FIG. 10A shows an example of a production system interface, according to some embodiments.

FIG. 10B shows an example of a content creation screen of a dedicated production application, according to some embodiments.

FIG. 10C shows an example of a publish/share screen of a dedicated production application, according to some embodiments.

FIG. 10D shows an example of a celebrity support services screen of a dedicated production application, according to some embodiments.

FIG. 10E shows an example of a countdown to live broadcast screen of a dedicated production application, according to some embodiments.

FIG. 11 shows an example of a plurality of digital devices, according to some embodiments.

FIG. 12A shows an example of a channel access interface, according to some embodiments.

FIG. 12B shows an example a celebrity content channel interface, according to some embodiments.

FIG. 13 shows an example of a Taylor Swift® channel interface, according to some embodiments.

FIG. 14A shows an example of an enhanced celebrity-content interface, according to some embodiments.

FIG. 14B shows an example of a countdown to a live broadcast of an enhanced celebrity-content interface, according to some embodiments.

FIG. 15 shows an example of a live celebrity-content interface, according to some embodiments.

FIG. 16 shows an example of a social media celebrity-content interface, according to some embodiments.

FIG. 17 shows an example of a video chat celebrity-content interface, according to some embodiments.

FIG. 18 shows an example of a video game celebrity-content interface, according to some embodiments.

FIG. 19 shows an example of a digital device, according to some embodiments.

FIG. 20 shows an example of a technology platform for implementing a celebrity portal, according to some embodiments.

### DETAILED DESCRIPTION OF EMBODIMENTS

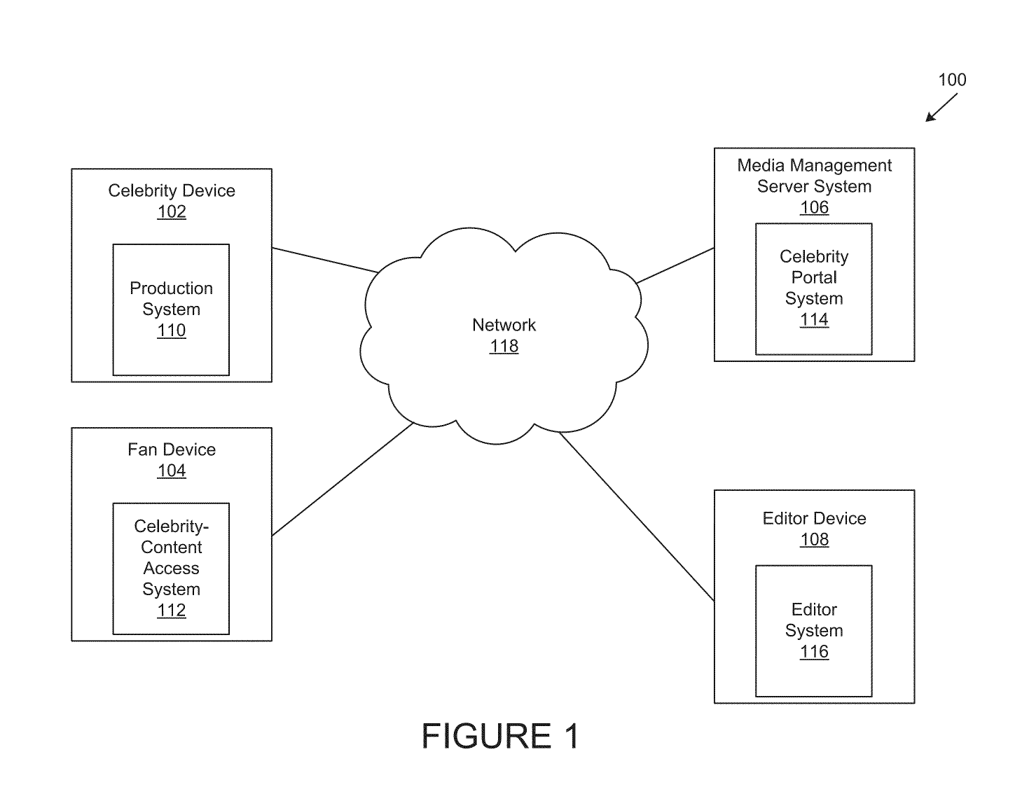

FIG. 1 shows an example of a celebrity portal environment 100, according to some embodiments. The celebrity portal environment 100 may allow fans of a celebrity to access an interactive portal of content related to the celebrity, herein referred to as a “celebrity channel” or “celebrity portal.” In the celebrity portal environment 100, a celebrity may act as a real-time producer of multi-media content and social media that is relevant to fans of the celebrity. The celebrity portal environment 100 may allow capture of content from the perspective of the celebrity. As a result, the celebrity portal environment 100 may provide a first-hand perspective of audio-visual experiences important to the celebrity at the time of the content capture. The celebrity portal environment 100 may provide fans with the ability to interact with the content generated by a celebrity as often as the content is generated. The celebrity portal environment 100 may also include editor systems that provide pre-publication review of content, content organization, and celebrity brand management.

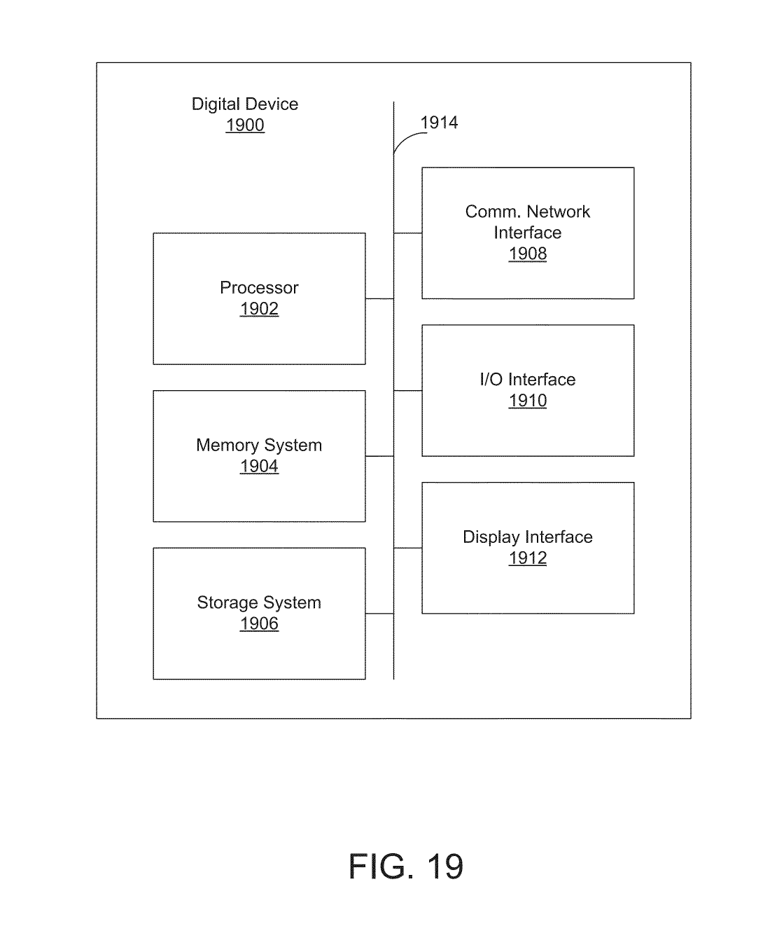

The celebrity portal environment 100 may include a celebrity device 102, a fan device 104, a media management server system 106, an editor device 108, and a network 118. Each of the celebrity device 102, the fan device 104, the media management server system 106, and the editor device 108 may comprise a digital device. As used herein, a digital device is a device with a memory and a processor. For instance, one or more of the celebrity device 102, the fan device 104, the media management server system 106, and the editor device 108 may include one or more elements of the digital device 1900 shown in FIG. 19.

Returning to the example of FIG. 1, the celebrity device 102 may include a production system 110. The production system 110 may be configured to allow a celebrity to generate multimedia and/or social media (collectively referred to hereinafter as “celebrity-generated content”). In some embodiments, the production system 110 may be configured to generate multimedia content. As used herein, multimedia is any combination of text, audio, still images, animation, video, and interactive content. To this end, the production system 110 may interface with a camera on the celebrity device 102. The camera may be configured to capture images and/or video. The production system 110 may also be adapted to generate illustrations or other drawings through input devices such as mice, trackpads, keyboards, touchscreen interfaces, or other input devices. As used herein, social media is any content adapted to use networking technologies to support interaction between a content producer and a content consumer. Examples of social media generated by the production system 110 include emails, instant messages (IMs), content from social networking services like Facebook®, Instagram®, Pinterest® and Twitter®, chat services like Google Chat®, video and group chat services (e.g., video chat “Hang Outs”®), and other services. The social media from the production system 110 may allow the user of the celebrity device 102 to interface with other users. For instance, the production system 110 may allow the celebrity to send or receive emails, IMs, messages from Facebook®, Instagram®, Pinterest® and Twitter® to other users. The production system 110 may also allow the celebrity to establish video chat or group chat sessions with other users.

In some embodiments, the celebrity-generated content generated by the production system 110 may be produced by a celebrity. A celebrity, as used herein, is a person, group of persons, or entity who is the focus of the celebrity channel. In some embodiments, the celebrity may be an agent of a person, group of persons, or entity who is the focus of the celebrity channel. The celebrity may be a public or private figure. Examples of public celebrities include actors/actresses, musicians, notable heirs/heiresses, athletes, politicians, authors, and others. Examples of public celebrities include corporations, athletic teams (e.g., professional football teams), music groups, groups of persons linked by an association, etc. The production system 110 may allow the celebrity to interface with fans. A fan, as used herein, is a person who is interested in the celebrity and/or the content of the celebrity. In various embodiments, the production system 110 may allow the celebrity to interface with one or more editors who manage the celebrity-generated content and manage the look and feel of a celebrity portal for the celebrity. As a result, the production system 110 may allow the celebrity the ability to contact one or more editors via email, chat services, a dedicated phone line, an Internet inquiry form, or other way.

In various embodiments, the production system 110 may be configured to facilitate celebrity engagement with a celebrity portal. As used herein, a celebrity portal is a channel of images, audio, video, text, animation, and social media related to the celebrity. The channel may include substantially real-time content, can contain mash-ups of content and can be continuously updated with news, multimedia content, and social media updates related to the celebrity. The celebrity portal may be configured to execute in a container application of the production system 110. Examples of container applications include: a mobile application, an application on a networked set-top box, a standalone computer application, or a web browser. In some embodiments, the celebrity portal may include edited content and/or content from fans. For instance, the celebrity portal may include Tweets® or social media messages from fans, as well as social media responses from the celebrity. As will be further discussed, the celebrity portal may facilitate real-time multimedia interactivity between a celebrity and his or her fans while safeguarding the celebrity's reputation and brand. Celebrity engagement may include the ability to view the celebrity portal while having the ability to modify the contents. As part of celebrity engagement, the production system 110 may allow the celebrity to supply edits or feedback to the celebrity portal. As part of celebrity engagement, the production system 110 may also allow the celebrity to prevent or limit publication of portions or all of the celebrity portal. In some embodiments, the celebrity portal may include a dedicated production application that allows a celebrity to share, by default, celebrity-generated content to populate a celebrity's channel. The dedicated production application may further share the celebrity-generated content to the celebrity's fans through social media. As a result, the dedicated production application may be configured to extend a celebrity's existing social content consumption flow through a series of interactions that unlock revenue and value from a celebrity's fans.

The fan device 104 may include a celebrity-content access system 112. The celebrity-content access system 112 may be configured to allow a fan to access the celebrity-generated content and to provide fan-generated multimedia and/or social media (collectively referred to hereinafter as “fan-generated content”). For instance, the celebrity-content access system 112 may be configured to access the celebrity content on the celebrity channel. The celebrity-content access system 112 may be configured to enable the fans to subscribe to the channel, to make postings in real-time, to be notified of postings, to interact with the celebrity, to comment on the celebrity, or to request or vote for certain content. Further, as part of generating fan-generated content, the celebrity-content access system 112 may interface with a camera on the fan device 104. The camera may be configured to capture images and/or video. The celebrity-content access system 112 may also be adapted to generate illustrations or other drawings through input devices such as mice, trackpads, keyboards, touchscreen interfaces, or other input devices.

The celebrity-content access system 112 may be configured to access and/or generate social media. For instance, the celebrity-content access system 112 may be configured to send emails, IMs, content from social networking services like Facebook® and Twitter®, content chat services like Google Chat®, content from video and group chat services (e.g., video chat “Hang Outs”®), and content from other services. The social media from the celebrity-content access system 112 may allow the fan to interface with other users, including the celebrity. As a result, the celebrity-content access system 112 may allow the fan to send or receive emails, IMs, Facebook® messages, tweets to celebrities and/or other fans. The celebrity-content access system 112 may also allow the fan to establish video chat or group chat sessions with other users. The celebrity-content access system 112 may allow the fan to interface with editors. In some embodiments, the celebrity-content access system 112 may display the celebrity channel. Portions of the celebrity channel may be configured to display reactive content, while other portions of the celebrity channel may be configured to display interactive content. Reactive content, as used herein, is content that a fan may consume without actively generating feedback about the content. Examples of reactive content may include a television broadcast, video broadcasts, music broadcasts, channel previews, channel selection, and lean-back user experiences. Interactive content, as used herein, is content that a fan may consume and actively generate feedback about. Examples of interactive content may include many forms of social media, instant messaging, video chat services, and lean-forward experiences.

The celebrity-content access system 112 may be configured to facilitate fan engagement with the celebrity portal. The celebrity portal may be configured to execute in a container application of the celebrity-content access system 112. For instance, the celebrity portal may be configured to execute in one or more of the following on the celebrity-content access system 112: a mobile application, an application on a networked set-top box, a standalone computer application, or a web browser. Fan engagement may include the ability to view the celebrity portal without the ability to modify the contents of the celebrity portal. As part of fan engagement, the celebrity-content access system 112 may allow the fan to provide social media related to multimedia on the celebrity portal. Fan engagement may also involve comments related to social media on the celebrity portal. In some embodiments, the celebrity-content access system 112 may also allow fans to contact editors to indicate inappropriate content or content that appears to violate digital rights or intellectual property rights.

The media management server system 106 may include a celebrity portal system 114. In some embodiments, the celebrity portal system 114 may be configured to manage celebrity-generated content generated by the celebrity device 102. For example, the celebrity portal system 114 may be configured to store, access, and/or manage images, video, illustrations, animation, and/or other content from the celebrity device 102. The celebrity portal system 114 may also be configured to interface with social media accounts associated with the celebrity. For instance, the celebrity portal system 114 may be configured to obtain emails, IMs, content from social networking services like Facebook®, Instagram®, Pinterest® and Twitter®, content from chat services like Google Chat®, content from video and group chat services (e.g., video chat “Hang Outs”®), and content from other services associated with the celebrity.

In various embodiments, the celebrity portal system 114 may be configured to manage fan-generated content generated by the fan device 104. As a result, the celebrity portal system 114 may be configured to store, access, and/or manage images, video, illustrations, animation, and/or other content from the fan device 104. The celebrity portal system 114 may also be configured to interface with social media accounts associated with the fan. For instance, the celebrity portal system 114 may be configured to obtain emails, IMs, content from social networking services like Facebook®, Instagram®, Pinterest® and Twitter®, content from chat services like Google Chat®, content from video and group chat services (e.g., video chat “Hang Outs”®), and content from other services associated with the fan.

The celebrity portal system 114 may be configured to facilitate editing the celebrity-generated content from the celebrity device 102. For instance, the celebrity portal system 114 may include a set of editing templates to clean up, modify, or manage portions of the celebrity-generated content. The editing templates may prove especially useful for ensuring celebrity-generated content are in line with a celebrity's specific brand. The celebrity portal system 114 may also be configured to create a celebrity portal that contains the celebrity-generated content from the celebrity and/or the fan. In various embodiments, the celebrity portal may include mash-ups of audio, video, text, social media, and connections to events, such as live or recorded performances. The celebrity portal system 114 may further be configured publish the celebrity portal to a web feed or to a format compatible with a container application. For instance, the celebrity portal system 114 may adapt the celebrity portal to be compatible with one or more of: a mobile application, an application on a networked set-top box, a standalone computer application, or a web browser.

The celebrity portal system 114 may be configured to provide celebrity support services. Celebrity support services, as used herein, are services related to fan interaction with celebrity-generated content and/or services involving direct communications between a celebrity and an editor. Celebrity support services may include data-driven feedback services such as: the number of fans or followers a celebrity has, the ranking of specific items of celebrity-generated content, and the impact of specific items of celebrity-generated content. In some embodiments, celebrity support services may include editorially driven feedback services such as: the top social reactions to specific items of celebrity-generated content, top comments to specific items of celebrity-generated content, news and/or blog reactions to specific items of celebrity-generated content, top fans and/or influencers of content generated by a particular celebrity, and/or other fan network updates. In various embodiments, celebrity support services may include concierge services that may or may not involve direct communications with an editor. Examples of concierge services include direct chat services with an editor, access to editor directories (e.g., email, phone, or profiles of editors), channel activity calendars, and/or scheduling/planning information. In some embodiments, celebrity support services may include notifications related to celebrity-generated content. Example of notifications include: when a new content related to celebrity-generated content was posted, new comments related to celebrity-generated content that have been posted, fan activity related to celebrity-generated content, and planning relating to notifications, countdowns, and reminders.

In some embodiments, the celebrity portal system 114 may be adapted to manage digital rights and/or intellectual property rights associated with the content in the celebrity portal. The celebrity portal system 114 may further be configured to perform analytics related to the celebrity portal. For instance, in various embodiments, the celebrity portal system 114 may determine usage statistics and patterns of use associated with various fans who seek to access the celebrity portal.

The editor device 108 may include an editor system 116. The editor system 116 may be configured to control the celebrity portal system 114 using instructions from an editor. In various embodiments, the editor system 116 may interface with a branding professional, such as a manager of the celebrity portal system 114. The editor system 116 may provide an editor with a set of application programming interfaces (APIs) that allow the editor to interface with the celebrity portal system 114. The APIs of the editor system 116 may allow the editor to provide instructions to the celebrity portal system 114 to edit celebrity-generated content and/or fan-generated content for publication into the celebrity portal. In some embodiments, the editor system 116 may include standalone applications and/or may itself implement portions of the celebrity portal system 114. More specifically, the editor system 116 may implement editing templates that allow an editor to enhance and/or edit content for publication into the celebrity portal.

In various embodiments, the editor system 116 may be configured to manage content in the celebrity portal system 114, such as celebrity-generated content and/or fan-generated content. In various embodiments, the editor system 116 may be configured to generate multimedia and/or social media (collectively referred to hereinafter as “editor-generated content”) on behalf of the celebrity and/or fans. The editor system 116 may further be configured to apply enhancements that modify the celebrity-generated content and/or fan-generated content. In some embodiments, the enhancements may be associated with editing templates that change the look and feel of the celebrity portal. In various embodiments, the editor system 116 may be configured to instruct the celebrity portal system 114 to publish the celebrity portal. The editor system 116 may also be configured to target social media creation associated with a celebrity portal.

Though FIG. 1 and the other figures elaborated upon herein discuss various embodiments in the context of a public celebrity and his or her fans, those of ordinary skill in the art will appreciate that other relationships between the users of the celebrity device 102 and the fan device 104 are possible. For instance, the fan may include one member of a family (e.g., a parent), while the celebrity may include another member of the family (e.g., a child). In some embodiments, the celebrity may include one member of an organization (e.g., an administrative professional), while the fan may include another member of the organization (e.g., a non-administrative professional). In various embodiments, the celebrity may include one member of a community (e.g., a politician or a public figure), while the fan may include another member of the community (e.g., a voter or a constituent). Accordingly, it is noted that various embodiments provide an interactive portal based on one user's relationship with another.

In some embodiments, the celebrity portal system 114 and the editor system 116 may be configured to facilitate publishing premium content to the celebrity portal. As used herein, premium content is any combination of celebrity-generated content, enhanced content, editor-generated content, and/or fan-generated content that is added to a celebrity channel as a bonus to the ordinary contents of the celebrity channel. Premium content may include content that has a price additional to the price required to access the celebrity channel. For instance, premium content may include pay-per-view content that requires a charge each time the content is accessed. Premium content may be available only to users of a certain subscription level. Premium content may include content that fans have to wait a specified time for. For example, premium content may comprise content, such as a live or a previously recorded but unpublished broadcast by a celebrity that is to be aired at a predetermined time. In some embodiments, premium content may include content that requires interactive engagement by a celebrity. For example, premium content may include one-to-one video chat sessions between a celebrity and fans. In various embodiments, the celebrity portal system 114 and the editor system 116 may also receive notice of a scheduled presentation of premium content on a celebrity portal and notify a set of fans of the scheduled presentation of the premium content.

The network 118 may include a set of devices interconnected by communication channels that allow the sharing, transmission, and/or reception of resources and information. The network 118 may include some combination of a wired network or a wireless network. In various embodiments, the network 118 may include some combination of a public network and a private network. Some or all of the network 118 may comprise the Internet. Though FIG. 1 designates element 118 as a “network,” those of ordinary skill in the art will appreciate that the element 118 may comprise a bus, a communication channel implemented on a computer-readable medium, or other system for communicating resources and/or information.

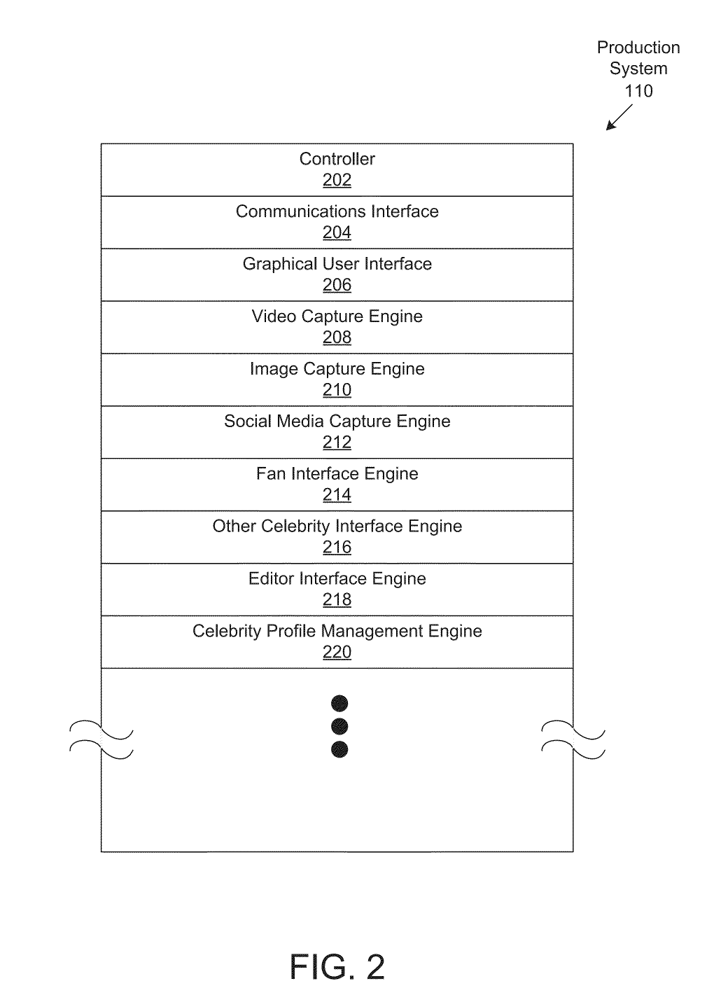

FIG. 2 shows an example of a production system 110, according to some embodiments. Some or all of the production system 110 may correspond to the production system 110 shown in FIG. 1. Returning to the example of FIG. 2, the production system 110 may include a controller 202, a communications interface 204, a graphical user interface 206, a video capture engine 208, an image capture engine 210, a social media capture engine 212, a fan interface engine 214, another celebrity interface engine 216, an editor interface engine 218, and a celebrity profile management engine 220. One or more of the controller 202, the communications interface 204, the graphical user interface 206, the video capture engine 208, the image capture engine 210, the social media capture engine 212, the fan interface engine 214, the other celebrity interface engine 216, the editor interface engine 218, and the celebrity profile management engine 220 may include hardware and/or software.

The controller 202 may include a central processing unit (CPU) and/or memory operative to implement instructions on the production system 110. The controller 202 may receive application and/or system level commands from a user and may translate the application and/or system level commands into machine instructions that direct portions of the production system 110 to operate. The controller 202 may also control the other elements of the production system 110. In this example, the controller 202 may implement an operating system (OS), applications, device drivers, and may control APIs on the production system 110. The communications interface 204 may couple the production system 110 to a network. The communications interface 204 may include a network interface card (NIC). In various embodiments, the communications interface 204 may be configured to interface with one or more of a wired network and a wireless network. In this example, the communications interface 204 may supply data from portions of the production system 110 to a network, and may provide data from the network to various portions of the production system 110. The graphical user interface 206 may be configured to allow users to interact with portions of the production system 110. The graphical user interface 206 may include menus, buttons, fields, and other graphical elements. Those of ordinary skill in the art will appreciate that the element 206 may designate other interfaces, such as text-based interfaces, as well.

The video capture engine 208 may be configured to obtain video from a video recording device operatively coupled to the production system 110. In some embodiments, the video capture engine 208 may receive a video stream from a video recording device and may provide the video stream to the communications interface 204. For instance, the video capture engine 208 may be adapted to receive a video stream from a webcam coupled to a digital device containing the production system 110. The video capture engine 208 may also be configured to receive video from a mobile phone camera on a mobile phone or a computing tablet containing the production system 110. Whatever the source of the video, the video capture engine 208 may be adapted to translate and/or compress the video into a form compatible with the communications interface 204. In various embodiments, the video capture engine 208 may also control the video recording device by supplying parameters such as a recording length or recording quality. The video capture engine 208 may be configured to monitor and gather some or all of the video content generated by a celebrity using the production system 110.

The image capture engine 210 may be configured to obtain an image from an image recording device (e.g., a camera) operatively coupled to the production system 110. The image capture engine 210 may be adapted to translate the image into a form compatible with the communications interface 204. In various embodiments, the image capture engine 210 may control the image recording device by supplying parameters such as an image quality. The image capture engine 210 may be configured to monitor and gather some or all of the images generated by a celebrity using the production system 110.

The social media capture engine 212 may be configured to capture social media generated by a celebrity. In various embodiments, the social media capture engine 212 may implement a set of APIs to interface with the hardware and/or software of social media service providers. For instance, the social media capture engine 212 may implement authorization APIs for email services, IM services, social networking services (e.g., ebook®, Instagram®, Pinterest® and Twitter®), chat services, video chat services, group chat services, and/or other services. The APIs used may be provided by the social media service providers. In some embodiments, the social media capture engine 212 may implement proprietary APIs designed to capture social media. As a result, the social media capture engine 212 may be configured to monitor and gather some or all of the social media generated by a celebrity using the production system 110.

The fan interface engine 214 may be configured to allow a celebrity to interface with fans. In various embodiments, the fan interface engine 214 may support IMs, chat services, video chat services, and group chat services, for instance. The fan interface engine 214 may also be adapted to receive fan questions, comments, and/or suggestions. Thus, the fan interface engine 214 may implement a set of APIs that interface with third-party and/or proprietary message boards, email accounts, chat services, and social media service providers. The APIs may be proprietary or provided by third-party service providers.

The other celebrity interface engine 216 may be configured to allow a celebrity to interface with other celebrities. In various embodiments, the other celebrity interface engine 216 may support IMs, chat services, video chat services, and group chat services. The other celebrity interface engine 216 may also be adapted to receive questions, comments, and/or suggestions from others designated as celebrities by a celebrity portal. The other celebrity interface engine 216 may implement a set of APIs that interface with third-party and/or proprietary message boards, email accounts, chat services, and social media service providers. The APIs may be proprietary or provided by third-party service providers. It will be appreciated that the other celebrity interface engine 216 may only allow communication with other celebrities as defined by certificates, permissions, or other certifying mechanisms.

The editor interface engine 218 may be configured to provide a celebrity with a direct link to editors, which may include branding professional and/or agents. In some embodiments, the editor interface engine 218 may include a link to email accounts, chat services, or social media service providers. In some embodiments, the editor interface engine 218 may be configured to provide the celebrity with celebrity support services. Examples of celebrity support services include data-driven feedback services, editorially driven feedback services, concierge services, and/or notifications related to celebrity-generated content. The editor interface engine 218 may use specialized APIs to facilitate these links and/or celebrity support services.

The celebrity profile management engine 220 may manage access and/or permissions to a celebrity portal. In some embodiments, the celebrity profile management engine 220 may include a celebrity's login credentials (e.g., username and/or password). The celebrity profile management engine 220 may also include various permissions settings, including the amount and types of content a celebrity wishes to place with the celebrity portal. For instance, a celebrity may designate the contents of one or more accounts or files as private or not worthy of publication. In that case, the celebrity profile management engine 220 may designate the content as protected and prevent transfer of the protected content to the celebrity portal. In some embodiments, the celebrity profile management engine 220 may interface with one or more components of a celebrity portal system (e.g., the celebrity portal system may include corresponding components that connect to the celebrity profile management engine 220).

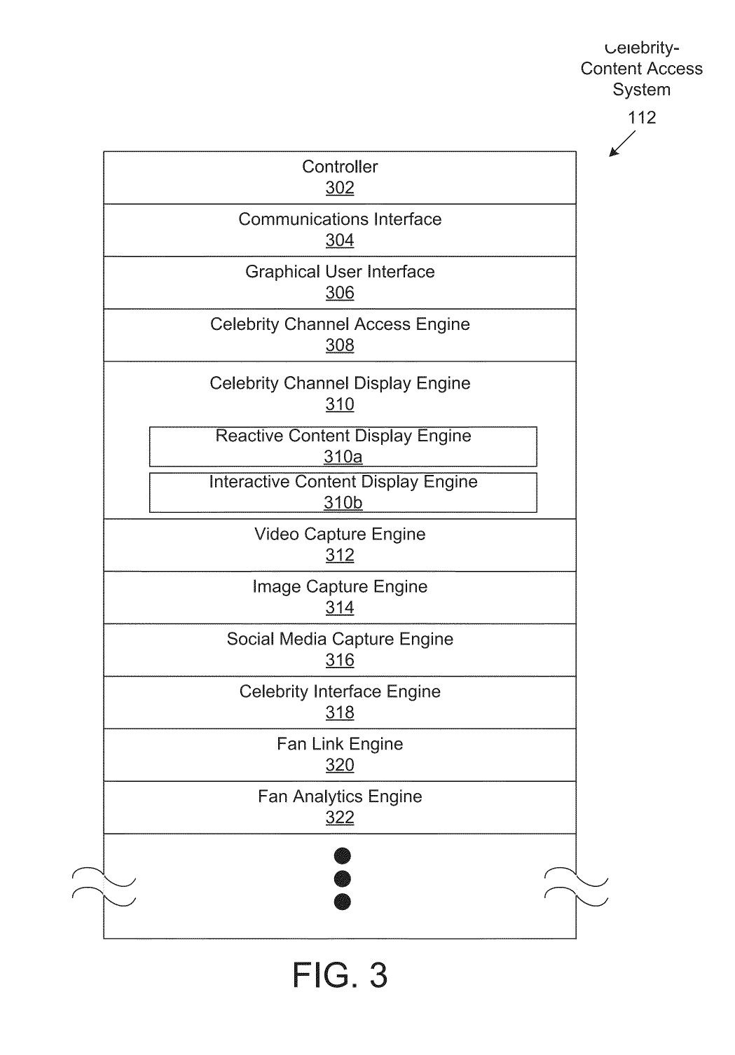

FIG. 3 shows an example of a celebrity-content access system 112, according to some embodiments. Some or all of the celebrity-content access system 112 may correspond to the celebrity-content access system 112 shown in FIG. 1. Returning to the example of FIG. 3, the celebrity-content access system 112 may include a controller 302, a communications interface 304, a graphical user interface 306, a celebrity channel access engine 308, a celebrity channel display engine 310, a video capture engine 312, an image capture engine 314, a social media capture engine 316, a celebrity interface engine 318, a fan link engine 320, and a fan analytics engine 322. One or more of the controller 302, the communications interface 304, the graphical user interface 306, the celebrity channel access engine 308, the celebrity channel display engine 310, the video capture engine 312, the image capture engine 314, the social media capture engine 316, the celebrity interface engine 318, the fan link engine 320, and the fan analytics engine 322 may include hardware and/or software.

The controller 302 may include a central processing unit (CPU) and/or memory operative to implement instructions on the celebrity-content access system 112. The communications interface 304 may include a network interface card (NIC) and may connect the celebrity-content access system 112 to a network. The graphical user interface 306 may be configured to allow users to interact with portions of the celebrity-content access system 112.

In the example of FIG. 3, the celebrity channel access engine 308 may be configured to facilitate logging into a celebrity portal. The celebrity channel access engine 308 may be adapted to facilitate selection of a celebrity channel associated with a specific celebrity. In some embodiments, a celebrity channel includes content that relates to a specific celebrity or group of celebrities. For instance, the celebrity channel access engine 308 may be adapted to facilitate selecting a Rihanna® channel containing content associated with the celebrity having that name, or a Taylor Swift® channel containing interactive celebrity content associated with the celebrity having that name. In some embodiments, the celebrity channel access engine 308 may be configured to check a fan's credentials (e.g., the fan's username/password). The celebrity channel access engine 308 may also be configured to verify whether a fan has a subscription to particular interactive celebrity content.

The celebrity channel display engine 310 may be adapted to allow a fan to view a celebrity portal. In various embodiments, the celebrity channel display engine 310 may allow a fan to view some combination of multimedia content and social media generated by a celebrity and possibly arranged or enhanced by an editor. In some embodiments, the celebrity channel display engine 310 may be configured to display the celebrity portal in a container application such as a mobile application, an application on a networked set-top box, a standalone computer application, or a web browser. In this example, the celebrity channel display engine 310 may comprise a reactive content display engine 310a and an interactive content display engine 310b. The reactive content display engine 310a may be configured to allow the fan to view reactive celebrity-generated content, reactive editor-generated content, and/or reactive fan-generated content. In some embodiments, the reactive content display engine 310a may configure an area of the fan's display to show the reactive content. The interactive content display engine 310b may be configured to allow the fan to view active celebrity-generated content, active editor-generated content, and/or active fan-generated content. In various embodiments, the interactive content display engine 310b may configure another area of the fan's display to show the interactive content. As a result, various embodiments allow a fan to view both reactive content and interactive content related to a celebrity on the same device. Further, the celebrity channel display engine 310 may allow a fan to engage in both lean-back and lean-forward content experiences on the same device at the same time.

The video capture engine 312 may be configured to obtain video from a video recording device operatively coupled to the celebrity-content access system 112. The video capture engine 312 may receive a video stream from a video recording device (e.g., a webcam or a mobile phone camera) and may provide the video stream to the communications interface 304. The video capture engine 312 may be adapted to translate and/or compress the video into a form compatible with the communications interface 304. The video capture engine 312 may also control the video recording device by supplying parameters such as a recording length or recording quality. The video capture engine 312 may be configured to monitor and gather some or all of the video content generated by a fan using the celebrity-content access system 112.

The image capture engine 314 may be configured to obtain an image from an image recording device (e.g., a camera) operatively coupled to the celebrity-content access system 112. The image capture engine 314 may be adapted to translate the image into a form compatible with the communications interface 304. In various embodiments, the image capture engine 314 may control the image recording device by supplying parameters such as an image quality. The image capture engine 314 may be configured to monitor and gather some or all of the images generated by a fan using the celebrity-content access system 112.

The social media capture engine 316 may be configured to capture social media generated by a fan. In various embodiments, the social media capture engine 212 may implement a set of APIs to interface with the hardware and/or software of social media service providers. Consequently, the social media capture engine 316 may be configured to monitor and gather some or all of the social media generated by a fan using the celebrity-content access system 112.

The fan link engine 320 may be configured to allow a fan to interface with other fans. In various embodiments, the fan link engine 320 may support IMs, chat services, video chat services, and group chat services. Thus, the fan link engine 320 may implement a set of APIs that interface with third-party and/or proprietary message boards, email accounts, chat services, and social media service providers. The APIs may be proprietary or provided by third-party service providers. As a result, the fan link engine 320 may provide fans using the celebrity-content access system 112 with a social media outlet for a real-time conversation relating to the celebrity portal.

The fan analytics engine 322 may be operative to monitor fan behavior, including multimedia content and social media generated by a fan. The fan analytics engine 322 may also monitor a fan's interaction with particular aspects of a given celebrity channel. In some embodiments, the fan analytics engine 322 may implement a set of APIs that link the celebrity-content access system 112 to a third-party analytics provider, such as Google® analytics. The fan analytics engine 322 may also implement a set of proprietary analytics services.

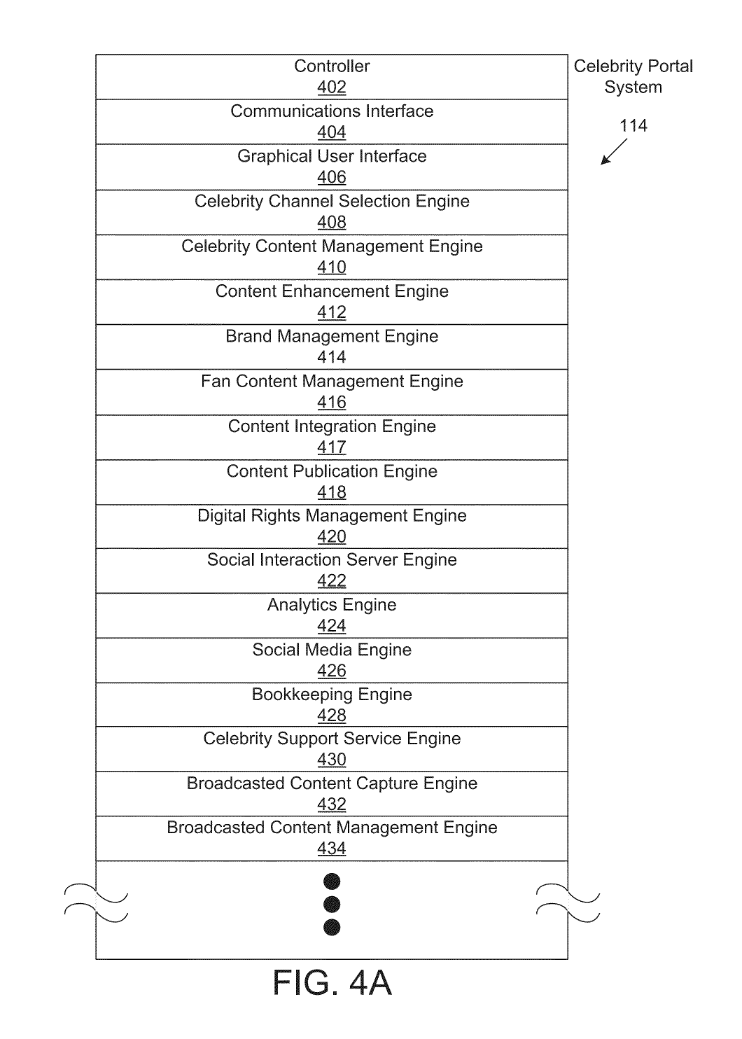

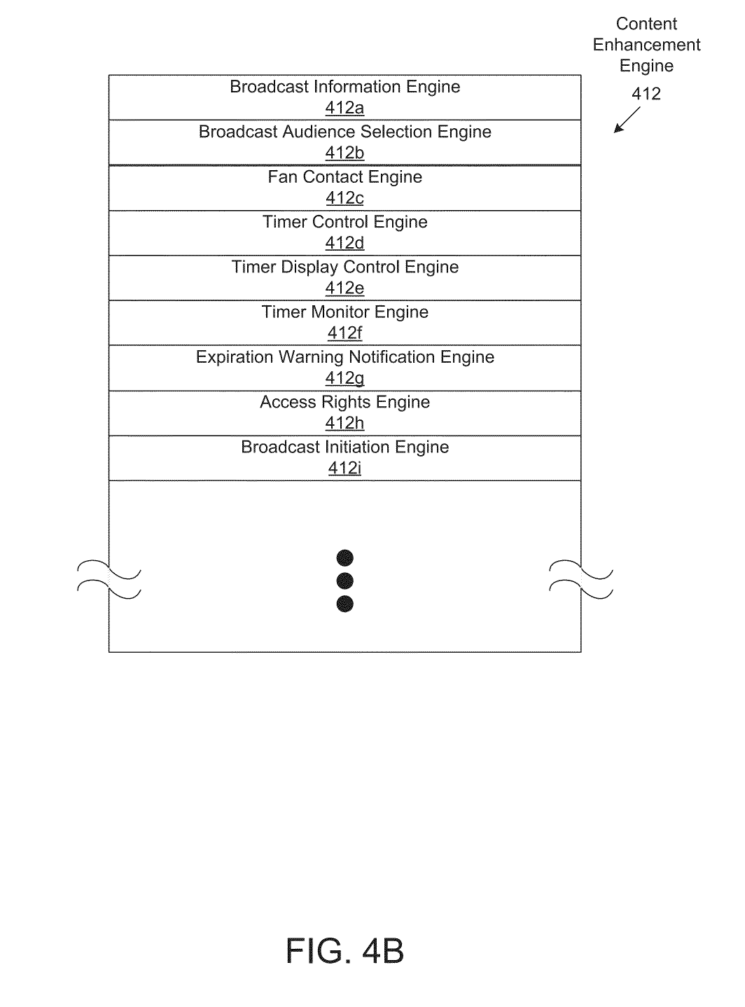

FIG. 4A shows an example of a celebrity portal system 114, according to some embodiments. Some or all of the celebrity portal system 114 may correspond to the celebrity portal system 114 shown in FIG. 1. Returning to the example of FIG. 4A, the celebrity portal system 114 may include a controller 402, a communications interface 404, a graphical user interface 406, a celebrity channel selection engine 408, a celebrity content management engine 410, a content enhancement engine 412, a brand management engine 414, a fan content management engine 416, a content integration engine 417, a content publication engine 418, a digital rights management engine 420, a social interaction server engine 422, an analytics engine 424, a social media engine 426, a bookkeeping engine 428, a celebrity support service engine 430, a broadcasted content capture engine 432, and a broadcasted content management engine 434. One or more of the controller 402, the communications interface 404, the graphical user interface 406, the celebrity channel selection engine 408, the celebrity content management engine 410, the content enhancement engine 412, the brand management engine 414, the fan content management engine 416, the content integration engine 417, the content publication engine 418, the digital rights management engine 420, the social interaction server engine 422, the analytics engine 424, the social media engine 426, the bookkeeping engine 428, the celebrity support service engine 430, the broadcasted content capture engine 432, and the broadcasted content management engine 434 may include hardware and/or software.

The controller 402 may include a central processing unit (CPU) and/or memory operative to implement instructions on the celebrity portal system 114. The communications interface 404 may include a network interface card (NIC) and may connect the celebrity portal system 114 to a network. The graphical user interface 406 may be configured to allow users to interact with portions of the celebrity portal system 114.

The celebrity channel selection engine 408 may be configured to select a profile of a celebrity or a set of celebrities for a celebrity channel. In some embodiments, the celebrity channel selection engine 408 may select a single celebrity for the celebrity channel. The celebrity channel selection engine 408 may also select a set of multiple celebrities for the celebrity channel. In various embodiments, the celebrity channel selection engine 408 may determine whether a celebrity channel already exists for the celebrity or set of celebrities. If a celebrity channel exists for the celebrity/set of celebrities, the celebrity channel selection engine 408 may load the celebrity channel into memory of the celebrity portal system 114. If a celebrity channel does not exist for the celebrity/set of celebrities, the celebrity channel selection engine 408 may allocate memory for the celebrity/set of celebrities. In that case, the celebrity channel selection engine 408 may then load portions of the new celebrity channel into the allocated memory.

The celebrity content management engine 410 may be configured to manage celebrity-generated content. In some embodiments, the celebrity content management engine 410 may receive celebrity-generated content directly from the celebrity. That is, the celebrity content management engine 410 may interface with various components of the production system 110 on the celebrity device 102 to ensure that celebrity-generated content is directly sent to the celebrity content management engine 410. For instance, the celebrity content management engine 410 may be adapted to interface, through the communications interface 404, with the video capture engine 208 in the production system 110 in FIG. 2. To this end, the celebrity content management engine 410 may receive video captured by a video capture engine 208 operatively coupled to the celebrity device 102. As discussed, the video may comprise video from a webcam, a mobile phone camera, or other video camera. In some embodiments, the celebrity content management engine 410 may decompress the video to ensure efficient playback. The celebrity content management engine 410 may also provide the video capture engine 208 with parameters such as recording length, recording quality, or other parameters. The celebrity content management engine 410 may also be adapted to interface, through the communications interface 404, with the image capture engine 210 in the production system 110 in FIG. 2. The celebrity content management engine 410 may receive images captured by the image capture engine 210 (e.g., a camera). The celebrity content management engine 410 may decompress or translate the image to a format and size convenient for publication. The celebrity content management engine 410 may also supply image parameters for the image. The celebrity content management engine 410 may further be configured to interface, through the communications interface 404, with the social media capture engine 212 in the production system 110 in FIG. 2. The celebrity content management engine 410 may receive emails, IMs, social networking data, chat data, video chat data, group chat data, and other data related to a celebrity's various social media accounts. Once a celebrity's Tweets®, Facebook® messages, chat logs, emails, and other data are captured, the celebrity content management engine 410 may associate the celebrity's social media with the celebrity's multimedia contents.

In various embodiments, the celebrity content management engine 410 may be configured to manage editor-generated content. More specifically, the celebrity content management engine 410 may receive editor generated content related to a celebrity from the editor system 116 on the editor device 108.

The content enhancement engine 412 may be configured to enhance celebrity-generated content based on the input of the editor of the editor device 108. The enhancements may ensure that the celebrity-generated content is properly branded. More specifically, the content enhancement engine 412 may receive a set of editing instructions from the editor. The editing instructions may include a set of effects, such as skin tone patches to remove blemishes, eye cover spots that remove red-eye effects from photos, stabilization filters that stabilize shaky video, and other editing effects. The effects may be stored locally or accessed via a network connection (e.g., an Internet connection). The editing instructions may also include text or animation to provide titles and other information. In some embodiments, the editing instructions may include a change to the actual content of multimedia and/or social media. For instance, the editing instructions may include deletion of offensive portions of messages, grammatical edits to messages, and text added to messages to accentuate a celebrity's brand. In various embodiments, the content enhancement engine 412 may receive additional multimedia content or social media from an editor. For example, the content enhancement engine 412 may receive videos or images from an editor for superimposition on content captured by a celebrity. The content enhancement engine 412 may also be configured to enhance fan-generated content based on the input of an editor.

In some embodiments, the content enhancement engine 412 may provide enhancements. As used herein, enhancements may include additions to celebrity-generated content that enhance the content or make celebrity-generated content into premium content. For instance, if a celebrity were to initiate a scheduled presentation of premium content, enhancements may include a countdown to the live broadcast. In some embodiments, enhancements may include selecting an audience of fans for the live broadcast, offering the audience an opportunity to purchase access rights to the live broadcast, and counting down to the live broadcast. In various embodiments, enhancements may include deletion of information, such as false or misleading information. Enhancements may also comprise a contest or sweepstakes for content. For instance, the content enhancement engine 412 may create a “lucky-fan” contest that allows a fan to “win” a one-on-one chat with a celebrity.

In various embodiments, the content enhancement engine 412 may prioritize the celebrity-generated content. In some embodiments, the content enhancement engine 412 may generate a “news feed” based on some combination of the celebrity-generated content. The news feed may list items based on a likely relevance to fans. In some embodiments, the news feed may employ chronological priority. In various embodiments, the news feed may employ an editorially based priority, where editing instructions decide the order of items. For instance, editing instructions may determine that a music star's fans are more likely to respond to items of video content than tweets. In this instance, the news feed may order video content items first to reach the music star's fans. The priority of the news feed may also depend on content popularity and/or engagement algorithms.

The brand management engine 414 may be configured to apply branding templates to ensure that a celebrity portal containing celebrity-generated content adequately reflects the brand of a celebrity. To this end, the brand management engine 414 may contain one or more branded templates that ensure a celebrity portal maintains a desired look and/or feel. The templates may be proprietary or developed by an editor. In some embodiments, the templates may depend on celebrity desire. For instance, a celebrity portal for a country-western star like Taylor Swift® may contain country themes. A celebrity portal for an urban pop star like Rihanna® may contain urban themes. A celebrity portal for a hip-hop artist may contain street-oriented themes. A celebrity portal for an heiress may contain themes of indulgence and affluence. Any of these themes may be brought into the celebrity portal to ensure a brand consistent with the celebrity's image.

The fan content management engine 416 may be configured to manage fan preferences and profiles of fans of a celebrity portal. The fan content management engine 416 may manage the accounts of fans seeking access to a specific celebrity portal or set of celebrity portals. The fan content management engine 416 may also be adapted to capture specific fan content, such as comments about celebrity portal content, requests for future performances and/or songs, and social media related to a celebrity. The fan content management engine 416 may further be configured to determine the types of content a specific fan wishes to access. That is, one fan may wish to access a larger volume of multimedia content while another fan may desire to access a larger volume of social media. The fan content management engine 416 may manage these preferences.

The content integration engine 417 may apply enhancements to celebrity-generated content and/or fan-generated content. As used herein, “enhancements” are multimedia and/or social media items used to modify celebrity-generated content and/or fan-generated content. Enhancements may include one or more of editing instructions, editing effects, text/animation, message edits, additional multimedia content and/or social media, branding information (e.g., trademarks and/or trade dress), and other items. In various embodiments, the enhancements may comprise portions of branding templates, as described with reference to the brand management engine 414. In some embodiments, the content integration engine 417 may be operated by a set of APIs accessed by an editor. As a result, an editor accessing the content integration engine 417 through an API may be able to compile a celebrity channel based on celebrity-generated content, as well as enhancing content. In some embodiments, the content integration engine 417 may create the celebrity channel to be accessible across a variety of devices. For instance, the content integration engine 417 may configure the celebrity channel to execute in a container application, such as a mobile application, an application on a networked set-top box, a standalone computer application, or a web browser.

The content publication engine 418 may also publish the celebrity channel. More specifically, the content publication engine 418 may create mash-ups that include a mesh of celebrity-generated content, fan-generated content, editor-generated content, and/or enhancements. The content publication engine 418 may also integrate value-added information into the content (e.g., a countdown to a live performance, depublication of false/misleading information). In some embodiments, the content publication engine 418 may update or refresh an existing celebrity channel with celebrity-generated content, fan-generated content, editor-generated content, and/or enhancements. In some embodiments, publication by the content publication engine 418 may involve separating content types into interactive content feeds and reactive content feeds. To this end, the content publication engine 418 may format at least portions of the celebrity channel to incorporate reactive celebrity-generated content, reactive editor-generated content, and/or reactive fan-generated content. The content publication engine 418 may further format at least other portions of the celebrity channel to incorporate active celebrity-generated content, active editor-generated content, and/or active fan-generated content. To publish the celebrity channel, the content publication engine 418 may access one or more web publication APIs to website service providers indicating that the celebrity channel should be immediately accessible by fans.

The digital rights management engine 420 may ensure that the content of the celebrity channel do not infringe the intellectual property rights of others or violate the digital rights of content producers. The digital rights management engine 420 may verify trademarks, trade dress, and/or branding data in the celebrity-generated content, the fan-generated content and/or the enhancements, for instance. In some embodiments, the digital rights management engine 420 may verify that celebrity-generated content is not copyrighted before being published to a celebrity channel.

The social interaction server engine 422 may be configured to connect celebrities to one another for the purpose of coordinating joint performances, including joint musical performances, joint chat sessions, and joint video chat sessions. The social interaction server engine 422 may also connect a celebrity to fans via, e.g., chat or video chat. In some embodiments, the social interaction server engine 422 may access third-party APIs that facilitate chat sessions and/or video chat sessions between account holders. In some embodiments, the social interaction server engine 422 may implement a secure, closed, and proprietary video chat network that requires a high level of security to access. As a result, the social interaction server engine 422 may provide celebrities with a high level of privacy when chatting with fans.

The analytics engine 424 may be configured to collect analytics related to a specific celebrity channel or set of celebrity channels. In various embodiments, the analytics engine 424 may determine how specific fans respond to specific items of celebrity-generated content. The analytics engine 424 may also monitor how specific fans respond to specific sets of celebrities. In some embodiments, the analytics engine 424 may determine fans' patterns of shopping or web browsing habits in response to interactions with a specific set of celebrity channels. The analytics engine 424 may access third-party APIs or proprietary APIs to collect analytics information.

The social media engine 426 may be configured to push portions of a celebrity channel to various social media outlets. For instance, updates to a given set of celebrity channels may be sent to social media sources to induce fans to tune into or refresh a specific channel. The social media engine 426 may access third-party APIs or proprietary APIs to perform these social media pushes.

The bookkeeping engine 428 may be configured to track revenue generated by a specific celebrity channel or set of celebrity channels. In some embodiments, the bookkeeping engine 428 may track the fees that fans are willing to pay to subscribe to a specific celebrity channel or set of celebrity channels. The bookkeeping engine 428 may also track the amount of revenue a specific celebrity channel or set of celebrity channels gains through advertisements or promotional offers. In various embodiments, bookkeeping engine 428 may track revenue gained through performances (e.g., concerts) for hire on the specific celebrity channel or set of celebrity channels. The bookkeeping engine 428 may also be adapted to track revenue generated through fans that pay per performance or use pay-per-view services of the specific celebrity channel or set of celebrity channels. The bookkeeping engine 428 may further be adapted to track revenue generated from a profit-sharing system that allows celebrities to earn a portion of the money raised through views of the specific celebrity channel or set of celebrity channels. In some embodiments, the bookkeeping engine 428 may track revenue from an online store or a website associated with the specific celebrity channel or set of celebrity channels, accessed via the specific celebrity channel, or accessed in response to viewing the specific celebrity channel.

The celebrity support service engine 430 may be configured to provide a celebrity with celebrity support services. In some embodiments, the celebrity support service engine 430 may be configured to provide a celebrity with data-driven feedback services such as: the number of fans or followers a celebrity has, the ranking of specific items of celebrity-generated content, and the impact of specific items of celebrity-generated content. The celebrity support service engine 430 may also be configured to provide the celebrity with editorially driven feedback services such as: the top social reactions to specific items of celebrity-generated content, top comments to specific items of celebrity-generated content, news and/or blog reactions to specific items of celebrity-generated content, top fans and/or influencers of content generated by a particular celebrity, and/or other fan network updates. In various embodiments, the celebrity support service engine 430 may provide concierge services such as: direct chat services with an editor, access to editor directories (e.g., email, phone, or profiles of editors), channel activity calendars, and/or scheduling/planning information. The celebrity support service engine 430 may also provide a celebrity include notifications related to celebrity-generated content, such as: when a new content related to celebrity-generated content was posted, new comments related to celebrity-generated content that have been posted, fan activity related to celebrity-generated content, and planning relating to notifications, countdowns, and reminders.

The broadcasted content capture engine 432 may be configured to capture portions of the interactive celebrity channel that was broadcasted. For instance, the broadcasted content capture engine 432 may be configured to capture portions of a live broadcast. The broadcasted content management engine 434 may be configured to manage captured portions of the interactive celebrity channel. In some embodiments, the broadcasted content management engine 434 may be adapted to store portions of a live broadcast.

FIG. 4B shows example details of the content enhancement engine 412 for enhancing a special broadcast of premium content, according to some embodiments. One skilled in the art will recognize that the elements of FIG. 4B may be parts of one or more elements of the celebrity portal system 114 or parts of the celebrity portal system 114. The content enhancement engine 412 may operate similarly to the content enhancement engine 412 in FIG. 4A. The content enhancement engine 412 may be adapted to receive a notification of a scheduled presentation of premium content, select an audience of fans for the scheduled presentation of premium content, offer the audience an opportunity to purchase access rights to the premium content, and provide a countdown to the scheduled presentation of premium content. The content enhancement engine 412 may include a broadcast information engine 412a, a broadcast audience selection engine 412b, a fan contact engine 412c, a timer control engine 412d, a timer display control engine 412e, a timer monitor engine 412f, an expiration warning notification engine 412g, an access rights engine 412h, and a broadcast initiation engine 412i. One or more of the broadcast information engine 412a, the broadcast audience selection engine 412b, the fan contact engine 412c, a timer control engine 412d, the timer display control engine 412e, the timer monitor engine 412f, the expiration warning notification engine 412g, the access rights engine 412h, and the broadcast initiation engine 412i may include hardware and/or software.

The broadcast information engine 412a may be configured to gather information of a scheduled presentation of premium content. Information of a scheduled presentation of premium content may include celebrity-generated content for the broadcast. The information of the scheduled presentation of premium content may include the time the presentation of the premium content is scheduled to begin. In some embodiments, the information of the scheduled presentation of premium content may include a content type of the premium content. For instance, the broadcast information engine 412a may be configured to obtain whether the premium content comprises streaming video, video chat content, IM content, or streaming audio content. In various embodiments, the information of the scheduled presentation of premium content may include the quality of the premium content, such as the bitrate, the pixel quality, and the minimum bandwidth required to stream various versions of the premium content. In some embodiments, the broadcast information engine 412a may receive the information of the premium content from the celebrity, from an editor, from an agent, from a third-party, from fans, etc. In some embodiments, the broadcast information engine 412a may receive a notification to begin a scheduled presentation of premium content at a particular time.

The broadcast audience selection engine 412b may be configured to select a target audience of fans for the scheduled presentation of premium content. In some embodiments, the target audience may include all of the fans of a given celebrity. The target audience may also include a set of fans who meet specified criteria associated with the scheduled presentation of premium content. More specifically, selecting the target audience may comprise identifying a set of fans who meet demographic criteria that would suggest interest in the premium content. In various embodiments, the target audience may include a set of fans a celebrity has given special rights to access the premium content. For example, the target audience may include a set of fans a celebrity has selected to attend a video chat session or a performance. For instance, the broadcast audience selection engine 412b may select a set of fans in a specific geographic region or of a particular age. The broadcast audience selection engine 412b may also select a set of fans with a specified network connection (e.g., fans having a 4G data connection or greater). In various embodiments, the broadcast audience selection engine 412b may select fans based on profiles gained from fan analytics, such as fans' web browsing habits, purchase patterns, and other analytics information.

In some embodiments, the broadcast audience selection engine 412b may be configured to select the target audience based on input from the editor system 116. The broadcast audience selection engine 412b may also select the target audience based the actions of fans. That is, the broadcast audience selection engine 412b may be configured to select the target audience based on social media, such as patterns based on whether associates of fans on social media “like,” “comment,” or otherwise interact with a fan's content that may be associated with the substance of the premium content. For instance, if a fan posted content about a celebrity on Facebook® or Pinterest®, the broadcast audience selection engine 412b may be configured to select the target audience based on whether friends of the fan liked the content.

The fan contact engine 412c may be configured to contact the target audience about the scheduled presentation of premium content. In some embodiments, the fan contact engine 412c may be adapted to refresh a celebrity channel of the celebrity who is the subject of the premium content. Refreshing the celebrity channel may include visually modifying the celebrity channel to notify the target audience about the scheduled presentation of premium content. In some embodiments, the fan contact engine 412c may refresh a news feed on the celebrity channel to notify the target audience. In various embodiments, the fan contact engine 412c may further be configured to contact fans using one or more contact methods, including email, IMs, and/or contacts to fans' social media accounts.

The timer control engine 412d may be configured to control a timer. In some embodiments, the timer control engine 412d may initiate a timer to countdown to the scheduled presentation of premium content. In some embodiments, the timer may be coupled to a clock (e.g., a system clock of the content enhancement engine 412) and be adapted to measure a specified time interval. The timer may be configured to display on the celebrity-content access system 112 as a visual depiction of the time remaining to the scheduled presentation of premium content. For example, the timer may be configured to display as an item of content integrated into a given celebrity channel. The integrated timer may decrement at a fixed frequency, such as a fixed frequency of a second. In various embodiments, the timer control engine 412d may initiate the timer by providing to the timer the specified time interval, the countdown frequency, and/or a signal to the timer to begin counting down to the scheduled presentation of premium content. The timer control engine 412d may also be configured to provide the expiration warning notification engine 412g with a predetermined time to provide a warning before expiry of the timer. In some embodiments, the timer control engine 412d may also be configured to manage processes and memory associated with the timer. The timer control engine 412d may, in various embodiments, be configured to instruct the timer to exit and clear memory associated with the timer.

The timer display control engine 412e may be configured to control the display of the timer on the celebrity-content access system 112. In some embodiments, the timer display control engine 412e may be adapted to control the look, feel, and/or ornamentation of the timer. The timer display control engine 412e may configure the size, colors, and patterns to control how the timer appears to a fan. The timer display control engine 412e may also control user interface elements (e.g., radio buttons, fields, and/or text boxes) that allow the fan to interact with the timer. In various embodiments, the timer display control engine 412e may configure the display of the timer to comport with a particular celebrity's brand and/or image. In various embodiments, the timer display control engine 412e may facilitate controlling the display of the timer before the timer control engine 412d has initiated the timer. The timer display control engine 412e may also facilitate controlling the display of the timer after the timer control engine 412d has initiated the timer.

The timer monitor engine 412f may be configured to monitor the timer. Monitoring the timer may involve supplying an editor with a reading of the amount of time remaining on the timer. As a result, the timer monitor engine 412f may allow an editor to determine the amount of time remaining in a countdown to a scheduled presentation of premium content. The timer monitor engine 412f may also be adapted to provide an editor with the ways a timer is displayed on various fan devices. For instance, the timer monitor engine 412f may provide an editor with how a particular timer appears across platforms, such as how the particular timer appears on an iPhone®, an Android® phone, an iPad®, an Android® tablet, and a Microsoft Windows® system. In various embodiments, the timer monitor engine 412f may allow an editor to override values of the timer, including the time remaining in a countdown and the display of the timer. As a result, the timer monitor engine 412f may allow an editor to manually control a timer, and control things such as a celebrity's brand and image, particularly in the case of a scheduled presentation of premium content that does not occur due to intervening events.

The expiration warning notification engine 412g may be configured to provide an expiration notification a predetermined time before expiry of the timer. In some embodiments, the expiration warning notification engine 412g base the expiration notification on the predetermined expiry time supplied by the timer control engine 412d during timer initiation. In various embodiments, the expiration warning notification engine 412g may provide the expiration notification to the timer display control engine 412e and/or the timer monitor engine 412f. The timer display control engine 412e may change the display of the timer to indicate that the timer is soon to expire. The timer monitor engine 412f may provide the expiration notification and/or other notifications to an editor.

The access rights engine 412h may be configured to control rights of fans to access the scheduled presentation of premium content. In some embodiments, the access rights engine 412h may be configured to maintain a list of fan rights. The fan rights may specify whether a fan of a celebrity channel is allowed to particular access portions of the celebrity channel. For instance, the fan rights may specify whether the fan is allowed to access a social media feed, video chat sessions, and/or specific broadcasts within a celebrity channel. In various embodiments, the fan rights may depend on whether a fan has paid for premium content on the celebrity channel, has a particular subscription level, or otherwise earned access rights. The fan rights may depend on the length of time a fan has subscribed to the celebrity channel, the frequency the fan accesses the celebrity channel, the particular actions a fan takes, and/or other factors, such as whether the fan subscribes to other celebrity channels similar to the celebrity channel. The fan rights may depend on whether a celebrity has given special permission to access premium content. In some embodiments, the access rights engine 412h may grant or deny access to particular items of content. If a fan lacks rights to access a particular item of content, the access rights engine 412h may be configured to offer the fan an option to purchase rights to access the scheduled presentation of premium content. In some embodiments, the access rights engine 412h may provide a fan with an offer to purchase access to the premium content.

The broadcast initiation engine 412i may be configured to initiate the scheduled presentation of premium content. In some embodiments, the broadcast initiation engine 412i may provide an instruction to load the premium content into a specified portion of the celebrity channel. For instance, the broadcast initiation engine 412i may direct a portion of the celebrity channel to display a celebrity's video chat session and/or live video performance. The broadcast initiation engine 412i may provide the instruction to load the premium content in response to or soon after expiry of the timer. By linking the initiation of the premium content with expiry of the timer, the broadcast initiation engine 412i may advantageously allow the celebrity-generated content to air only after editors have had time to determine whether the premium content is consistent with the celebrity's image. As a result, by tightly coupling the initiation of the premium content with expiry of the timer, the broadcast initiation engine 412i may further protect the brand and/or privacy of a celebrity. In other embodiments, the presentation of the premium content occurs at a particular time, and need not be coupled to the timer specifically.

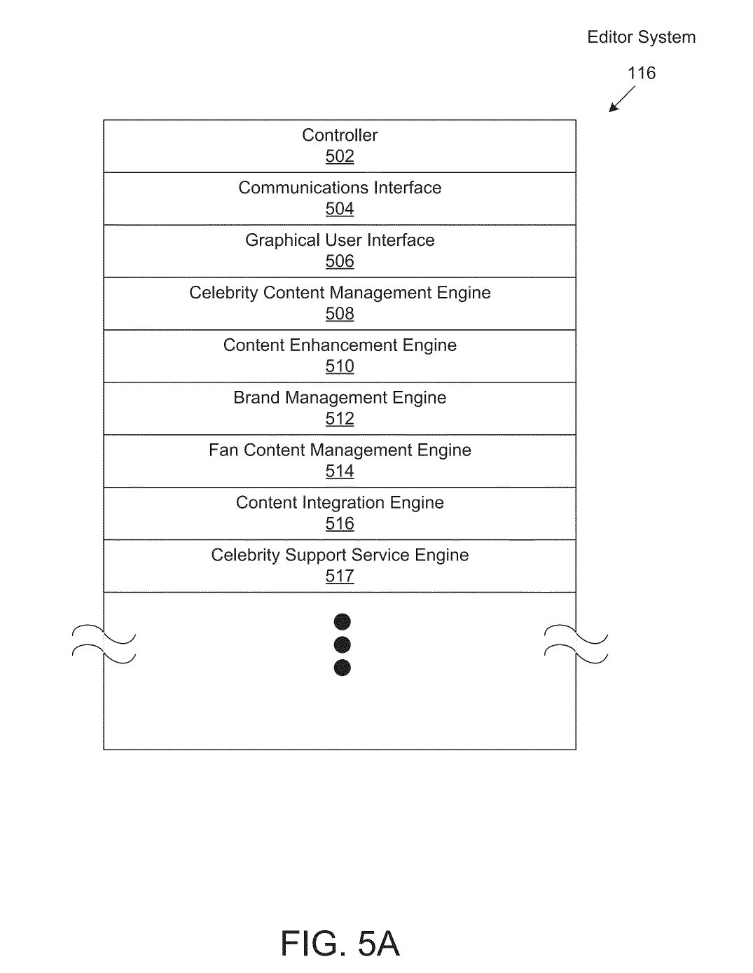

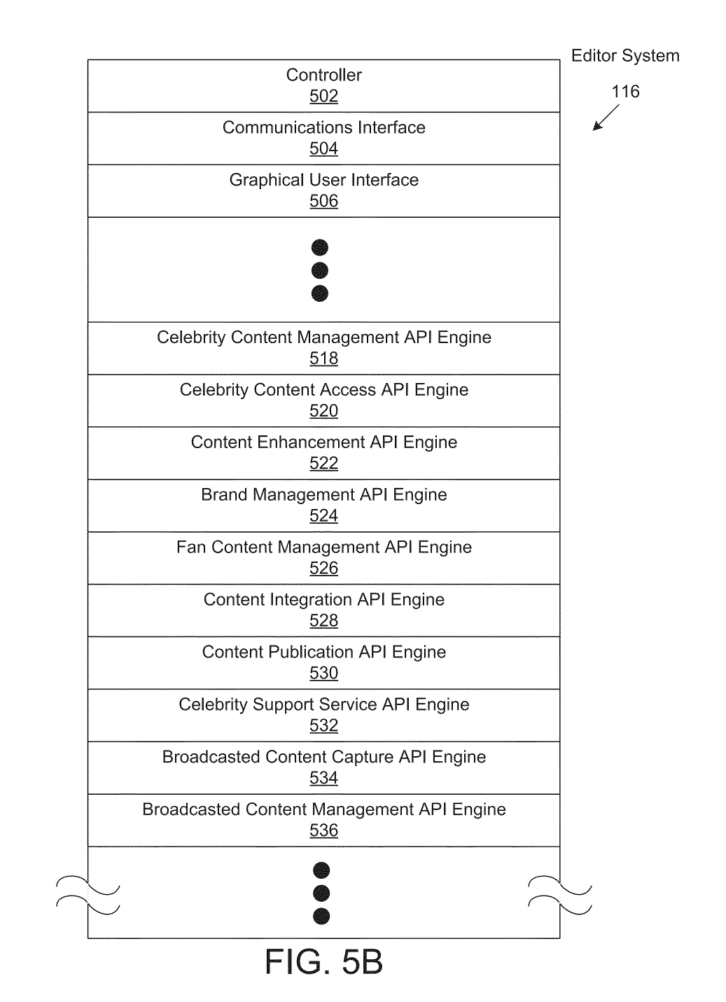

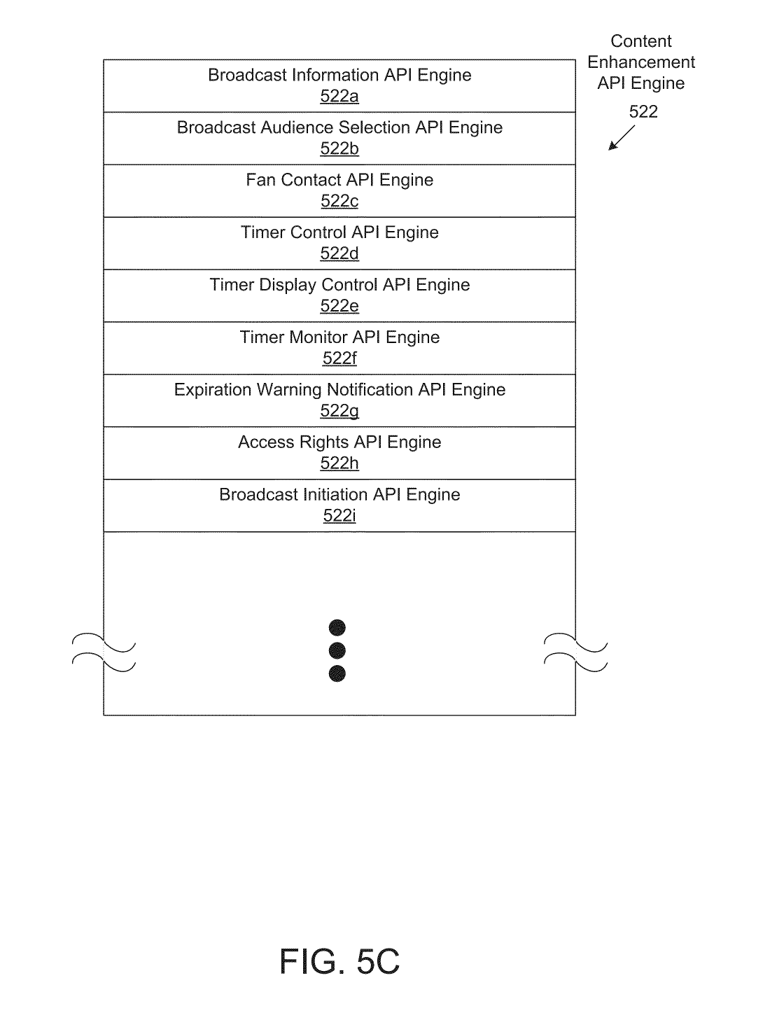

FIGS. 5A and 5B show examples of an editor system 116, according to some embodiments. Some or all of the editor system 116 in FIGS. 5A and 5B may correspond to the editor system 116 shown in FIG. 1. In the editor system 116 of FIG. 5A, there is shown a set of engines that allow an editor to enhance content and integrate enhanced content into a celebrity portal. The engines in the editor system 116 in FIG. 5A may function similarly to or replace one or more of the engines in the celebrity portal system 114 in FIG. 4A. The engines in the editor system 116 in FIG. 5A may or may not be coupled to one or more API engines, shown in FIG. 5B.

The editor system 116 in FIG. 5A may include a controller 502, a communications interface 504, a graphical user interface 506, a celebrity content management engine 508, a content enhancement engine 510, a brand management engine 512, a fan content management engine 514, a content integration engine 516, and a celebrity support service engine 517. One or more of the controller 502, the communications interface 504, the graphical user interface 506, the celebrity content management engine 508, the content enhancement engine 510, the brand management engine 512, the fan content management engine 514, the content integration engine 516, and the celebrity support service engine 517 may contain hardware and/or software.

The controller 502 may include a central processing unit (CPU) and/or memory operative to implement instructions on the editor system 116. The communications interface 504 may include a network interface card (NIC) and may connect the editor system 116 to a network. The graphical user interface 506 may be configured to allow users to interact with portions of the editor system 116.

The celebrity content management engine 508 may be configured to manage celebrity-generated content and/or editor-generated content. In some embodiments, the celebrity content management engine 508 may be configured to receive instructions from an editor to manage and/or access the celebrity-generated content and/or the editor-generated content. As will be discussed below, the instructions may or may not come from the celebrity content management API engine 518 and/or the celebrity content access API engine 520, shown in the editor system 116 of FIG. 5B. The celebrity content management engine 508 may be adapted to operate similarly to the celebrity content management engine 410 in the celebrity portal system 114 shown in FIG. 4A.

The content enhancement engine 510 may be configured to provide enhancement. The content enhancement engine 510 may be configured to receive instructions from an editor to enhance celebrity-generated content and/or editor-generated content. The instructions may or may not come from the content enhancement API engine 522, shown in the editor system 116 of FIG. 5B. The content enhancement engine 510 may be adapted to operate similarly to the content enhancement engine 412 in the celebrity portal system 114 shown in FIG. 4A. Further, consistent with FIG. 4B, the content enhancement engine 510 may include one or more of the broadcast information engine 412a, the broadcast audience selection engine 412b, the fan contact engine 412c, a timer control engine 412d, the timer display control engine 412e, the timer monitor engine 412f, the expiration warning notification engine 412g, the access rights engine 412h, and the broadcast initiation engine 412i.

The brand management engine 512 may be configured to apply branding templates to ensure that a celebrity portal containing celebrity-generated content adequately reflects the brand of a celebrity. The brand management engine 512 may be configured to receive instructions from an editor to apply the branding information. The instructions may or may not come from the brand management API engine 524, shown in the editor system 116 of FIG. 5B. The brand management engine 512 may be adapted to operate similarly to the brand management engine 414 in the celebrity portal system 114 shown in FIG. 4A.

The fan content management engine 514 may be configured to manage fan preferences and profiles of fans of a celebrity portal. The fan content management engine 514 may be configured to receive instructions from an editor to manage the fan preference/profile information. The instructions may or may not come from the fan content management API engine 526, shown in the editor system 116 of FIG. 5B. The fan content management engine 514 may be adapted to operate similarly to the fan content management engine 416 in the celebrity portal system 114 shown in FIG. 4A.

The content integration engine 516 may be configured to apply enhancements to celebrity-generated content and/or fan-generated content. The content integration engine 516 may also provide instructions to the celebrity portal system 114 to publish the celebrity channel. In various embodiments, the content integration engine 516 may be adapted to operate similarly to the content integration engine 417 in the celebrity portal system 114 shown in FIG. 4A.

The celebrity support service engine 517 may be configured to provide celebrity support services. The celebrity support service engine 517 may also be configured to receive instructions from an editor to manage celebrity support services. The celebrity support service engine 517 may be adapted to operate similarly to the celebrity support service engine 430 in FIG. 4A.

Turning to FIG. 5B, the figure shows a set of API engines that allow an editor to provide instructions to enhance content and integrate enhanced content into a celebrity portal. As will be discussed herein, the API engines in the editor system 116 in FIG. 5B may, in some embodiments, couple to one or more engines in the celebrity portal system 114 in FIG. 4A. In various embodiments, the API engines in the editor system 116 in FIG. 5B may couple to one or more engines in the editor system 116 in FIG. 5A.

FIG. 5B shows an example of an editor system 116, according to some embodiments. Some or all of the editor system 116 may correspond to the editor system 116 shown in FIG. 1. Returning to the example of FIG. 5B, the editor system 116 may include a controller 502, a communications interface 504, a graphical user interface 506, a celebrity content management API engine 518, a celebrity content access API engine 520, a content enhancement API engine 522, a brand management API engine 524, a fan content management API engine 526, a content integration API engine 528, a content publication API engine 530, and a celebrity support service API engine 532. One or more of the communications interface 504, the graphical user interface 506, the celebrity content management API engine 518, the celebrity content access API engine 520, the content enhancement API engine 522, the brand management API engine 524, the fan content management API engine 526, the content integration API engine 528, the content publication API engine 530, and the celebrity support service API engine 532 may contain hardware and/or software.

The controller 502 may include a central processing unit (CPU) and/or memory operative to implement instructions on the editor system 116. The communications interface 504 may include a network interface card (NIC) and may connect the editor system 116 to a network. The graphical user interface 506 may be configured to allow users to interact with portions of the editor system 116.

As will be discussed below, the celebrity content management API engine 518, the celebrity content access API engine 520, the content enhancement API engine 522, the brand management API engine 524, the fan content management API engine 526, and the content integration API engine 528 may include API engines. The API engines may provide instructions to portions of the celebrity portal system 114 and/or portions of the editor system 116 to edit celebrity-generated content and/or fan-generated content.

The celebrity content management API engine 518 may be configured to provide instructions to manage celebrity content for a celebrity channel. In some embodiments, the celebrity content management API engine 518 may interface, via the communications interface 504, to the celebrity content management engine 410 in FIG. 4A. In some embodiments, the celebrity content management API engine 518 may interface with the celebrity content management engine 508 in FIG. 5A. The celebrity content management API engine 518 may provide instructions to manage edit rights and may include editor permission settings. In some embodiments, the celebrity content management API engine 518 may provide instructions to manage certain media types a celebrity wishes to keep private. The celebrity content management API engine 518 may also provide instructions to implement rules to evaluate whether media is worthy of publication. For example, the celebrity content management API engine 518 may implement rules that determine not to publish content from a particular celebrity after a certain hour of the day to protect the celebrity from publishing content likely to harm the celebrity's reputation. In various embodiments, the celebrity content management API engine 518 may provide instructions to coordinate the celebrity's media preferences.

The celebrity content access API engine 520 may be configured to provide instructions to access specific items of celebrity-generated content. In some embodiments, the celebrity content access API engine 520 may interface, via the communications interface 504, to the celebrity content management engine 410 in FIG. 4A. In some embodiments, the celebrity content access API engine 520 may interface with the celebrity content management engine 508 in FIG. 5A. The celebrity content access API engine 520 may be configured to index celebrity-generated content on the celebrity content management engine. The celebrity content access API engine 520 may also provide the celebrity content management engine with recording parameters, recording format requirements, and the types of content that would be relevant to a particular celebrity. For instance, if a celebrity's performance is social media, the celebrity content access API engine 520 may ensure that the celebrity's social media content is given prominence. Conversely, if a musician performs music video content, the celebrity content access API engine 520 may ensure the celebrity's video content is given prominence.

The content enhancement API engine 522 may be configured to provide instructions to enhance celebrity-generated content. The content enhancement API engine 522 may be adapted to interface, via the communications interface 504, to the content enhancement engine 412 in FIG. 4A. In some embodiments, the content enhancement API engine 522 may interface with the content enhancement engine 510 in FIG. 5A. In some embodiments, the content enhancement API engine 522 may provide a set of enhancements to ensure that the celebrity-generated content appears professional. For instance, the content enhancement API engine 522 may provide instructions to apply a set of editing effects, text or animation, deletion of messages, grammatical edits to messages, and/or text added to messages to maximize a celebrity's brand value, among other features. The content enhancement API engine 522 may further provide instructions to provide additional multimedia content or social media from an editor. For instance, the content enhancement API engine 522 may provide instructions to apply videos or images for superimposition on celebrity-generated content. In various embodiments, the content enhancement API engine 522 may provide instructions to apply value-added information to celebrity-generated content. For example, the content enhancement API engine 522 may provide instructions to provide a countdown to a live performance, instructions to verify the validity of a celebrity's assertions, instructions to modify/delete false or misleading information, etc. In various embodiments, the content enhancement API engine 522 may order the items of celebrity-generated content in a news feed having a priority. The priority may be chronological, depend on editing instructions, depend on content popularity/engagement algorithms, and/or other factors.

The brand management API engine 524 may be configured to provide instructions to apply branding templates to ensure that a celebrity channel containing celebrity-generated content adequately reflects the desired branding. The brand management API engine 524 may be adapted to interface, via the communications interface 504, to a brand management engine (e.g., the brand management engine 414 in FIG. 4A). In some embodiments, the brand management API engine 524 may interface with the brand management engine 512 in FIG. 5A.

The fan content management API engine 526 may be configured to provide instructions to manage fan preferences and profiles of fans of a celebrity channel. The fan content management API engine 526 may be adapted to interface, via the communications interface 504, to the fan content management engine 416 in FIG. 4A. In some embodiments, the fan content management API engine 526 may interface with the fan content management engine 514 in FIG. 5A. The fan content management API engine 526 may be configured to provide instructions to indicate which content types fans want, which items of fan-generated content are to be inserted into a celebrity channel, etc.

The content integration API engine 528 may be configured to provide instructions to integrate enhancements into the celebrity channel. The content integration API engine 528 may be adapted to interface, via the communications interface 504, to the content integration engine 417 in FIG. 4A. In some embodiments, the content integration API engine 528 may interface with the content integration engine 516 in FIG. 5A. The content integration API engine 528 may therefore provide instructions to integrate enhancements that update or refresh an existing celebrity channel with celebrity-generated content, fan-generated content, editor-generated content, and/or enhancements.

The content publication API engine 530 may be configured to provide instructions to publish the celebrity channel. The content publication API engine 530 may be adapted to interface, via the communications interface 504, to the content publication engine 418 in FIG. 4A. In some embodiments, the content publication API engine 530 may access web publication APIs on behalf of the content publication engine 418. The content publication API engine 530 may provide instructions to publish and/or update content on an existing celebrity channel with celebrity-generated content, fan-generated content, editor-generated content, and/or enhancements.

The celebrity support service API engine 532 may be configured to provide instructions to supply celebrity support services to a celebrity using the celebrity channel. The celebrity support service API engine 532 may be adapted to interface, via the communications interface 504, to the celebrity support service engine 430 in FIG. 4A. In some embodiments, the celebrity support service API engine 532 may interface with the celebrity support service engine 517 in FIG. 5A.

FIG. 5C shows an example of a content enhancement API engine 522, according to some embodiments. The content enhancement API engine 522 may be part of the editor system 116, part of one or more of the elements of the celebrity portal system 114, part of the production system 110, and/or the like. The content enhancement API engine 522 may operate similarly to the content enhancement API engine 522 in FIG. 5B. In some embodiments, the content enhancement API engine 522 may be adapted to control the content enhancement engine 412 in FIG. 4B using a set of API engines. As a result, the content enhancement API engine 522 may be configured to instruct the content enhancement engine 412 to: gather information about a scheduled presentation of premium content, select an audience of fans for the scheduled presentation of premium content, offer the audience an opportunity to purchase access rights to the scheduled presentation of premium content, and provide a countdown to the scheduled presentation of premium content.

The content enhancement API engine 522 may include a broadcast information API engine 522a, a broadcast audience selection API engine 522b, a fan contact API engine 522c, a timer control API engine 522d, a timer display control API engine 522e, a timer monitor API engine 522f, an expiration warning notification API engine 522g, an access rights API engine 522h, and a broadcast initiation API engine 522i. One or more of the broadcast information API engine 522a, the broadcast audience selection API engine 522b, the fan contact API engine 522c, the timer control API engine 522d, the timer display control API engine 522e, the timer monitor API engine 522f, the expiration warning notification API engine 522g, the access rights API engine 522h, and the broadcast initiation API engine 522i may include hardware and/or software.

The broadcast information API engine 522a may be configured to provide instructions to gather information about a scheduled presentation of premium content. The broadcast information API engine 522a may be adapted to interface, via the communications interface 504 in FIG. 5B, to the broadcast information engine 412a in FIG. 4B or a corresponding engine in FIG. 5A. The broadcast audience selection API engine 522b may be configured to provide instructions to select a target audience of fans for the scheduled presentation of premium content. The broadcast audience selection API engine 522b may be adapted to interface, via the communications interface 504 in FIG. 5B, to the broadcast audience selection engine 412b in FIG. 4B or a corresponding engine in FIG. 5A.

The fan contact API engine 522c may be configured to provide instructions to contact the target audience about the scheduled presentation of premium content. The fan contact API engine 522c may be adapted to interface, via the communications interface 504 in FIG. 5B, to the fan contact engine 412c in FIG. 4B or a corresponding engine in FIG. 5A. The timer control API engine 522d may be configured to provide instructions to control a timer. In some embodiments, the timer control API engine 522d may be adapted to initiate a timer, control the timer, and/or exit the timer. The timer control API engine 522d may be adapted to interface, via the communications interface 504 in FIG. 5B, to the timer control engine 412d in FIG. 4B or a corresponding engine in FIG. 5A.

The timer display control API engine 522e may be configured to control the display of a timer. The timer display control API engine 522e may be adapted to interface, via the communications interface 504 in FIG. 5B, to the timer display control engine 412e in FIG. 4B or a corresponding engine in FIG. 5A. The timer monitor API engine 522f may be configured to provide instructions to monitor the timer. The timer monitor API engine 522f may be adapted to interface, via the communications interface 504 in FIG. 5B, to the timer monitor engine 412f in FIG. 4B or a corresponding engine in FIG. 5A.

The expiration warning notification API engine 522g may be configured to receive expiration notifications relating to the timer. The expiration warning notification API engine 522g may be adapted to interface, via the communications interface 504 in FIG. 5B, to the expiration warning notification engine 412g in FIG. 4B or a corresponding engine in FIG. 5A.

The access rights API engine 522h may be configured to provide instructions to control rights of fans to access a scheduled presentation of premium content. In some embodiments, the access rights API engine 522h may be adapted to provide instructions to maintain a list of fan rights, grant or deny access to particular items of content that a fan does not have right to access, and/or to offer the fan an option to purchase rights to access the scheduled presentation of premium content. The access rights API engine 522h may be adapted to interface, via the communications interface 504 in FIG. 5B, to the access rights engine 412h in FIG. 4B or a corresponding engine in FIG. 5A. The broadcast initiation API engine 522i may be configured to provide instructions to initiate the scheduled presentation of premium content. The broadcast initiation API engine 522i may be adapted to interface, via the communications interface 504 in FIG. 5B, to the broadcast initiation engine 412i in FIG. 4B or a corresponding engine in FIG. 5A.

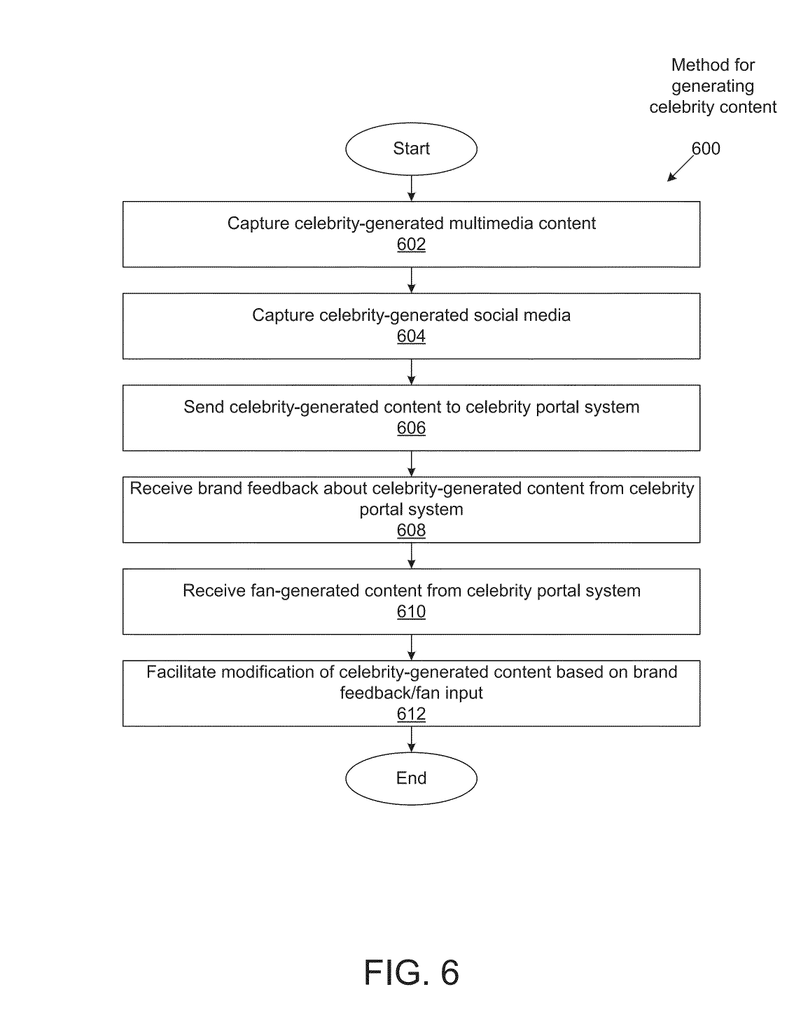

FIG. 6 shows an example of a method 600 for generating celebrity content, according to some embodiments. The method 600 is discussed in conjunction with a processor and a memory of the production system 110 in FIG. 2. It is noted that other structures may enable the method 600. It is also noted that the method 600 may contain substeps not illustrated, and that it may be possible to perform the inventive concepts shown in the method 600 without executing all of the steps in the method 600.

At step 602, the video capture engine 208 and/or the image capture engine 210 may capture celebrity-generated multimedia content. The video capture engine 208 may capture video content using a video camera (e.g., a webcam or a mobile phone camera) operatively coupled to the production system 110. The video capture engine 208 may capture video using a video camera. The capture may be based on instructions from a celebrity operating the production system 110, an editor, an automated process, or other way. Similarly, the image capture engine 210 may capture an image using a camera operatively coupled to the production system 110. It is noted that multimedia content may be captured in other ways in accordance with step 602. For instance, in various embodiments, an input device (e.g., a mouse, a trackpad, a touchscreen) may capture multimedia content comprising an illustration or animation.

At step 604, the social media capture engine 212 may capture celebrity-generated social media. The social media capture engine 212 may obtain, via authorization APIs for instance, emails, IMs, social networking messages (e.g., messages over Facebook®, Instagram®, Pinterest® and Twitter®), chat logs, video chat logs, group chat logs, and/or other social media. The social media capture engine 212 may store the social media locally (e.g., by caching the social media) or may direct components of the celebrity portal system 114 in FIG. 4A to store and/or access the social media.

At step 606, the communications interface 204 may send the celebrity-generated content to the celebrity portal system 114 in FIG. 4A. In various embodiments, the communications interface 204 may encode the celebrity-generated content to a format suitable for transmission over a network medium.

At step 608, the editor interface engine 218 may receive brand feedback about the celebrity-generated content from the celebrity portal system. More specifically, the editor interface engine 218 may receive information from branding templates or other brand feedback about the celebrity-generated content from the celebrity portal system 114. In some embodiments, the brand feedback may include suggestions as to how to better tailor content for the needs of fans or to enhance a celebrity's image. Brand feedback may also include industry-specific advice, such as how to make content more relevant to a celebrity's market.

At step 610, the fan interface engine 214 may receive fan-generated content from the celebrity portal system. In some embodiments, the fan interface engine 214 may receive video, audio, animations, images, and social media from fans. The fan interface engine 214 may, in various embodiments, allow fans to chat, video chat, or group chat with the celebrity. The contents of the fan-generated content may vary depending on the needs of a given celebrity. For instance, in some embodiments, fan-generated content may strictly relate to the material a celebrity has uploaded. However, fan-generated content may be broader and may relate to a celebrity's specific lifestyle or the celebrity's interests. As a result, the fan interface engine 214 may allow fans to closely interact with a celebrity in the real-life context of content that the celebrity generates.

Step 612 comprises facilitating modification of the celebrity-generated content based on the brand feedback and/or the fan-generated content. In some embodiments, the celebrity profile management engine 220 may allow a celebrity to manage his or her preferences based on the brand feedback and/or the fan-generated content. Further, in various embodiments, one or more of the video capture engine 208, the image capture engine 210, and the social media capture engine 212 may direct capture of additional content based on the brand feedback and/or the fan-generated content.

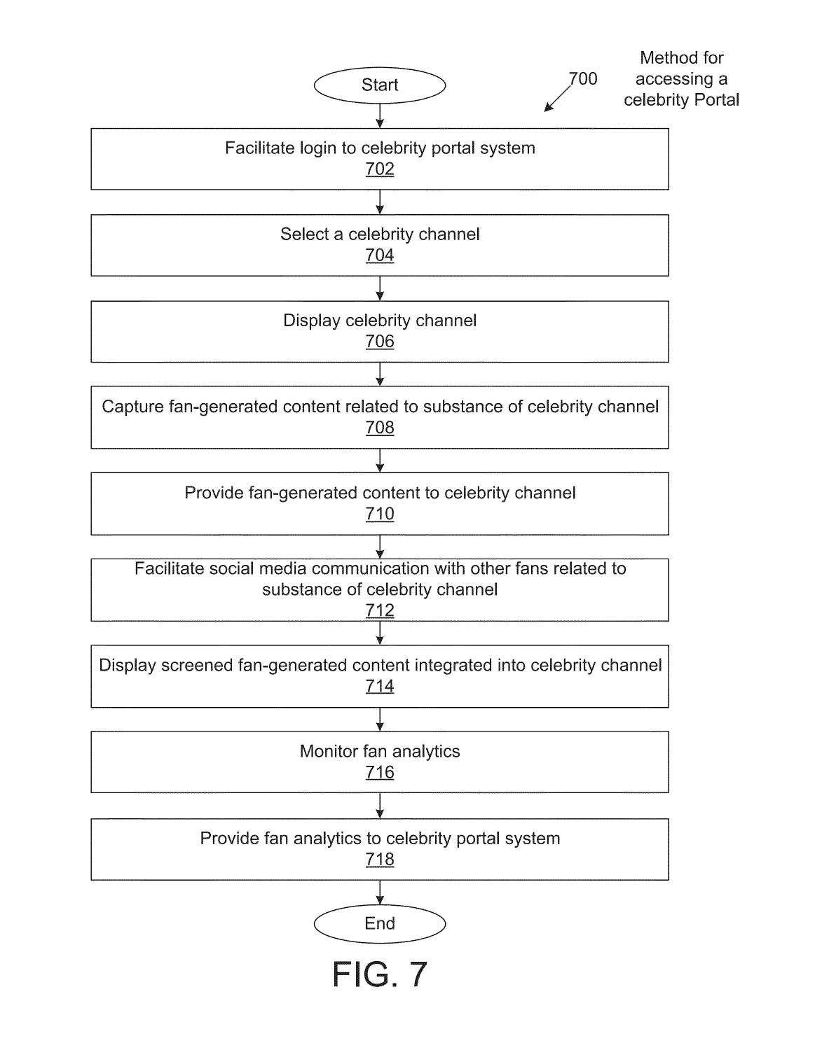

FIG. 7 shows a flowchart of an example of a method 700 for accessing a celebrity portal, according to some embodiments. The method 700 is discussed in conjunction with a processor and a memory of the celebrity-content access system 112 in FIG. 3. It is noted that other structures may enable the method 700. It is also noted that the method 700 may contain substeps not illustrated, and that it may be possible to perform the inventive concepts shown in the method 700 without executing all of the steps in the method 700.

At step 702, the celebrity channel access engine 308 may facilitate login to the celebrity portal system 114. In some embodiments, the celebrity channel access engine 308 may allow a fan to provide authentication credentials (e.g., a username and a password) so that the fan can login into the celebrity portal system 114. The login may determine which channels of content a fan has access to. In some embodiments, the determination of content access may depend on whether the fan has subscribed to a specified set of interactive celebrity content.

At step 704, the celebrity channel access engine 308 may select a celebrity channel that relates to a specific celebrity or group of celebrities. The celebrity channel access engine 308 may be adapted to determine whether a fan is allowed to access interactive content related to specific celebrities, such as a Rihanna® channel and/or a Taylor Swift® channel.

At step 706, the celebrity channel display engine 310 may display the celebrity channel. In some embodiments, the celebrity channel display engine 310 may allow a fan to view some combination of multimedia content and social media generated by the celebrity and possibly moderated by an editor. The celebrity channel display engine 310 may be configured to display the celebrity portal in a container application such as a mobile application, an application on a networked set-top box, a standalone computer application, or a web browser.

Step 708 comprises capturing fan-generated content related to the substance of the celebrity channel. The video capture engine 312 may be configured to obtain video from a video recording device operatively coupled to the celebrity-content access system 112. Further, the image capture engine 314 may be configured to obtain an image from an image recording device (e.g., a camera) operatively coupled to the celebrity-content access system 112. Also, the social media capture engine 316 may be configured to capture social media generated by the fan.

At step 710, the communications interface 304 may provide fan multimedia content to the celebrity channel. The communications interface 304 may encode the fan multimedia content into a format suitable for network transmission.

Step 712 comprises facilitating social media communication with other fans related to the substance of the celebrity channel. In some embodiments, the fan link engine 320 may connect the fan to other fans. The fan link engine 320 may apply subject-specific filters to ensure that communications relate to the substance of the celebrity channel. Additional filters may be applied by editors and/or celebrities. The social media capture engine 316 may capture social media streams generated by the fan. The communications interface 304 may allow transmission of the social media communications to and from other fans.

At step 714, the celebrity channel display engine 310 may display screened fan-generated content integrated into the celebrity channel. The celebrity channel display engine 310 may configure the celebrity portal to display in a container application such as a mobile application, an application on a networked set-top box, a standalone computer application, or a web browser.

At step 716, the fan analytics engine 322 may monitor fan analytics. The fan analytics engine 322 may be operative to monitor fan behavior, including multimedia content and social media generated by a fan. The fan analytics engine 322 may also monitor a fan's interaction with particular aspects of a given celebrity portal or channel.

At step 718, the communications interface 304 may provide the fan analytics to the celebrity portal system. The communications interface 304 may encode the fan analytics content into a format suitable for network transmission.

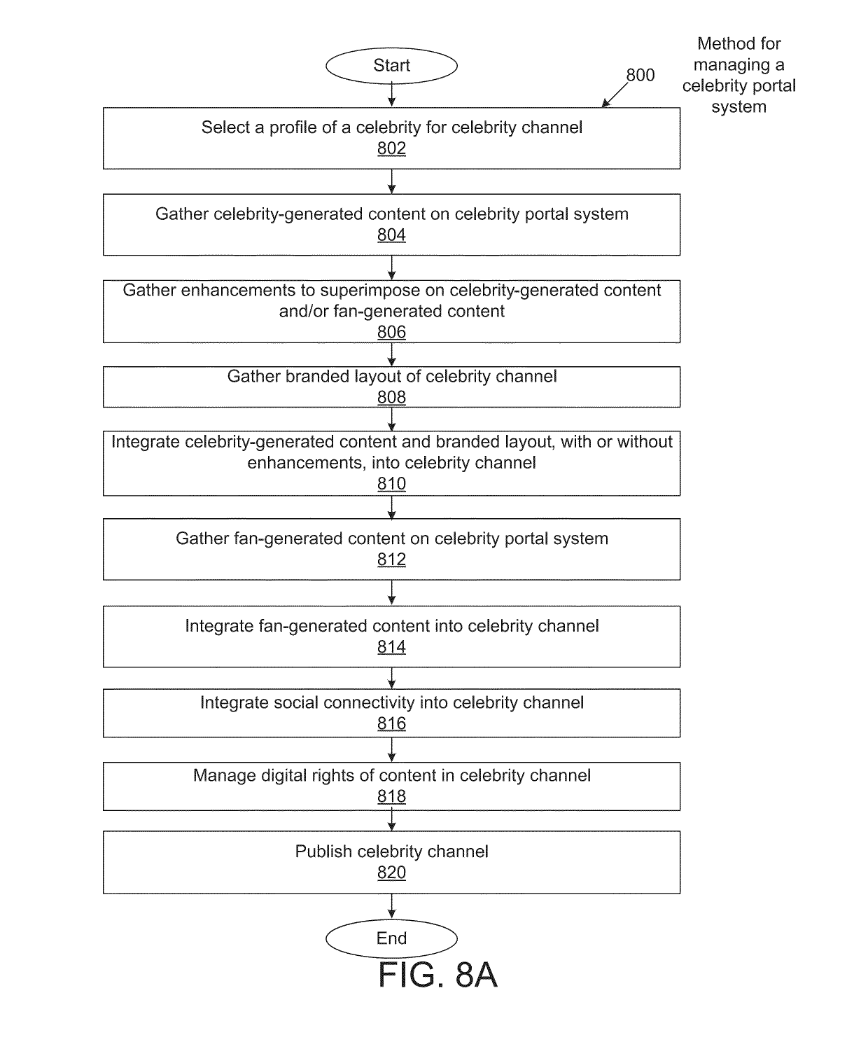

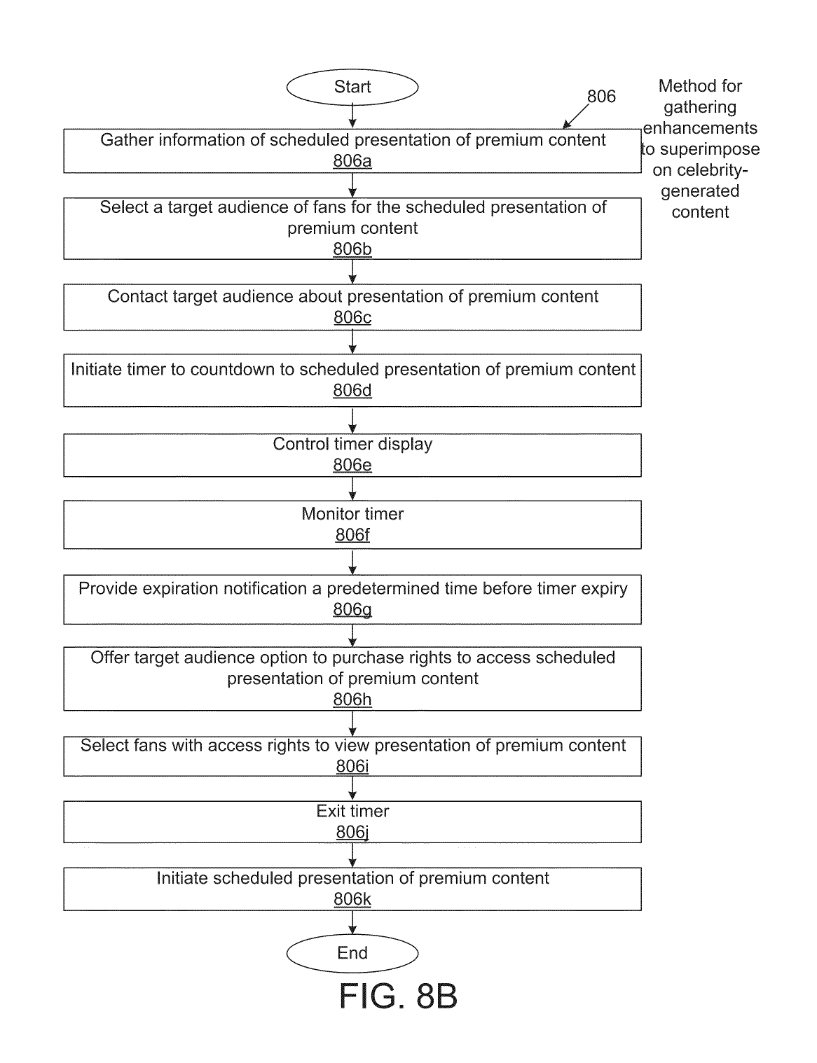

FIG. 8A shows a flowchart of an example of a method 800 for managing a celebrity portal, according to some embodiments. The method 800 is discussed in conjunction with a processor and a memory of the celebrity portal system 114 in FIG. 4A. It is noted that other structures may enable the method 800. It is also noted that the method 800 may contain substeps not illustrated, and that it may be possible to perform the inventive concepts shown in the method 800 without executing all of the steps in the method 800.

At step 802, the celebrity channel selection engine 408 may select a profile of a celebrity for a celebrity channel. In some embodiments, the celebrity channel selection engine 408 may select a single celebrity or set of celebrities for the celebrity channel. The set of celebrities may be grouped on common interests, themes, or genres. For instance, the celebrity channel selection engine 408 may select a group of country-western singers, a group of singers who are about the same age, or a group of celebrities who belong to common social circles. The celebrity channel selection engine 408 may also select a group of celebrities who appeal to common marketing audiences. The grouping may be based on agreement of the celebrities. In various embodiments, the celebrity channel selection engine 408 may perform the selection by loading an existing celebrity channel into memory of the celebrity portal system 114. The celebrity channel selection engine 408 may also allocate memory for a new celebrity channel and load portions of the new celebrity channel into the allocated memory. In various embodiments, the celebrity content management engine 508 in the editor system 116 in FIG. 5A may also perform step 802.

At step 804, the celebrity content management engine 410 may gather celebrity-generated content on the celebrity portal system 114. To perform this step, the celebrity content management engine 410 may gather video content, audio content, images, and other multimedia content generated by a celebrity. The celebrity content management engine 410 may also gather a celebrity's emails, IMs, social networking data, chat data, video chat data, group chat data chat logs, and other data. In various embodiments, the celebrity content management engine 410 may gather the celebrity-generated content based on the instruction from an editor system on an editor device. In various embodiments, the celebrity content management engine 508 in the editor system 116 in FIG. 5A may also perform step 804.

At step 806, the content enhancement engine 412 may gather enhancements to superimpose on the celebrity-generated multimedia content, the celebrity-generated social media, the fan-generated multimedia content, and/or the fan-generated social media. In various embodiments, the content enhancement engine 412 may apply enhancements, such as skin tone patches to remove blemishes, eye cover spots that remove red-eye effects from photos, stabilization filters that stabilize shaky video, and other editing effects. The content enhancement engine 412 may also apply text or animation to provide titles and other information. The content enhancement engine 412 may change the substance or form of celebrity-generated content, fan-generated content, and/or add editor-generated content, or may delete offensive portions of messages, provide grammatical edits to messages, or add text to messages to accentuate a celebrity's brand. Enhancements may come from a celebrity, a fan, an editor, or someone else. In some embodiments, the content enhancement engine 412 may add a countdown of the time to a live performance or targeted web searches to verify the validity of a celebrity's assertions. In various embodiments, the content enhancement engine 412 may order portions of the celebrity-generated content, the fan-generated content, and/or the editor-generated content, into a news feed having a priority. The priority may depend on one or more of a chronological priority, an editor-determined priority, and content popularity/engagement algorithms. In various embodiments, the content enhancement engine 510 in the editor system 116 in FIG. 5A may also perform step 806.

At step 808, the brand management engine 414 may gather a branded layout of the celebrity channel. The brand management engine 414 may gather the brand based on the celebrity's value or brand. In some embodiments, the brand management engine 414 may gather a brand template for the celebrity channel. In various embodiments, the brand management engine 512 in the editor system 116 in FIG. 5A may also perform step 808.

At step 810, the content integration engine 417 may integrate the celebrity-generated multimedia content, the celebrity-generated social media, and the branded layout, with or without the enhancements, into the celebrity channel. The content integration engine 417 may place the celebrity-generated multimedia content, the celebrity-generated social media, and the branded layout, with or without enhancements into portions of the celebrity channel to create a real-time feed relevant to fans of the celebrity. In various embodiments, the content integration engine 516 in the editor system 116 in FIG. 5A may also perform step 810.

At step 812, the fan content management engine 416 may gather fan-generated content on the celebrity portal system 114. The fan content management engine 416 may gather video content, audio content, images, and other multimedia content generated by a fan. The fan content management engine 416 may also gather a fan's emails, IMs, social networking data, chat data, video chat data, group chat data chat logs, and other data. In various embodiments, the fan content management engine 416 may gather the fan-generated content based on the instruction from an editor system on an editor device. In various embodiments, the fan-generated content is related to the celebrity-generated content. For instance, the fan content management engine 416 may employ keyword or subject filters to ensure that fan comments relate to a specific item of celebrity-generated content. The fan content management engine 416 may also employ third-party APIs (e.g., APIs to social networking sites) to ensure that fan content is germane to celebrity content. The fan content management engine 416 may also use filters to discard comments that are irrelevant or offensive. In various embodiments, the fan content management engine 514 in the editor system 116 in FIG. 5A may also perform step 812.

Step 814 comprises integrating the fan-generated content into the celebrity channel. The content integration engine 417 may apply enhancing content and/or branding templates to given pieces of celebrity-generated content. In some embodiments, the content integration engine 417 may configure the celebrity channel to execute in a container application, such as a mobile application, an application on a networked set-top box, a standalone computer application, or a web browser. The content integration engine 417 may update or refresh an existing celebrity channel with multimedia content, social media, enhancing content, branding templates, and other information. The content integration engine 417 may also publish the celebrity portal. More specifically, the content integration engine 417 may create mash-ups that include a mesh of multimedia content and social media, enhanced to reflect the celebrity's brand. The content integration engine 417 may also integrate enhancements into the content (e.g., a countdown to a live performance, depublication of false/misleading information). In various embodiments, the content integration engine 516 in the editor system 116 in FIG. 5A may also perform step 814.

At step 816, the social interaction server engine 422 may integrate social connectivity into the celebrity channel. In various embodiments, the social interaction server engine 422 may connect celebrities to fans or to one another for the purpose of coordinating joint performances, including joint musical performances, joint chat sessions, and joint video chat sessions.

At step 818, the digital rights management engine 420 may manage digital rights of the content in the celebrity channel. In some embodiments, the digital rights management engine 420 may verify trademarks and/or branding data. In some embodiments, the digital rights management engine 420 may verify that celebrity-generated content is not copyrighted before being published to a celebrity portal.

At step 820, the content publication engine 418 may publish the celebrity channel. Publishing the celebrity channel may include creating a new celebrity channel and/or updating an existing celebrity channel. To publish the celebrity portal, the content publication engine 418 may access one or more web publication APIs to website service providers indicating that the celebrity portal should be immediately accessible by fans. In some embodiments, the content publication engine 418 may update or refresh an existing celebrity portal with multimedia content, social media, enhancing content, branding templates, and other information. In various embodiments, the social media engine 426 may be configured to push portions of the celebrity channel to various social media outlets.

FIG. 8B shows a flowchart of an example of a method 806 for gathering enhancements to superimpose on celebrity-generated content. In some embodiments, the method 806 may correspond to the step 806, shown in FIG. 8A. The method 806 is discussed in conjunction with a processor and a memory of the content enhancement engine 412 in FIG. 4B. It is noted that other structures may enable the method 806. It is also noted that the method 806 may contain substeps not illustrated, and that it may be possible to perform the inventive concepts shown in the method 806 without executing all of the steps in the method 806.

At step 806a, the broadcast information engine 412a may gather information of a scheduled presentation of premium content. In some embodiments, the broadcast information engine 412a may receive a notification of a scheduled presentation of premium content. The notification may come from the celebrity generating the content for the scheduled presentation of premium content from a celebrity or an agent using the production system 110, from an editor using the editor system 118, and/or from a third party. The scheduled presentation of premium content may comprise an upcoming live performance, a video chat session, an IM session, and/or a prerecorded performance to be aired at an upcoming time. In various embodiments, the broadcast information engine 412a may gather the time of the scheduled presentation, whether the scheduled presentation of premium content comprises content such as streaming video, video chat content, IM content, or streaming audio content, and/or the quality of the premium content.

At step 806b, the broadcast audience selection engine 412b may select a target audience of fans for the scheduled presentation of premium content. The broadcast audience selection engine 412b may identify a set of fans who meet selection criteria for the scheduled presentation of premium content. In various embodiments, the target audience may include all of a celebrity's fans. The target audience may also include, in some embodiments, fans who meet demographic criteria for the scheduled presentation of premium content, fans whose analytics match marketing needs of the scheduled presentation of premium content, and/or fans whose social media may be linked to the needs of the scheduled presentation of premium content.

At step 806c, the fan contact engine 412c may contact the target audience about the scheduled presentation of premium content. The fan contact engine 412c may refresh portions of the interactive celebrity channel to notify the target audience about the scheduled presentation of premium content. The fan contact engine 412c may further refresh a news feed and/or contact fans through email, IMs, and/or social media. At step 806d, the timer control engine 412d may initiate a timer to count down to the scheduled presentation of premium content. In some embodiments, the timer control engine 412d may create a timer instance on fan devices, set a specified time interval for the timer, set a countdown frequency for the timer, and/or set a signal for the timer to begin counting down to the scheduled presentation of premium content.

At step 806e, the timer display control engine 412e may control the display of the timer on the celebrity-content access system 112. In some embodiments, the timer display control engine 412e may control the way the timer visually appears on the celebrity-content access system 112. At step 806f, timer monitor engine 412f may monitor the timer. The timer monitor engine 412f may supply an editor with a reading of the amount of time remaining on the timer, may provide the editor with a visual depiction of the timer on various fan platforms, and may provide an editor with how much time remains on the timer. At step 806g, the expiration warning notification engine 412g may provide an expiration notification a predetermined time before expiry of the timer. In some embodiments, the predetermined time may depend on a value from the timer control engine 412d.

At step 806h, the access rights engine 412h may offer the target audience an option to purchase rights to access the scheduled presentation of premium content. In various embodiments, the option to purchase the premium content may appear in the celebrity channel as a request to purchase the premium content. The access rights engine 412h may also provide a link to a website and/or an online store, a request for a credit card on online account (e.g., Paypal® account), or a link to a stored credit card or stored online account to facilitate a purchase. At step 806i, the access rights engine 412h may select fans with access rights to view the scheduled presentation of premium content. In various embodiments, the access rights engine 412h may check whether members of the target audience have rights commensurate with the permissions required to view the premium content. The access rights engine 412h may check one or more of each member's membership class, subscription levels, length of membership, frequency of channel access, social media, and/or other earned access rights.

At step 806j, the timer control engine 412d may exit the timer. In various embodiments, the timer control engine 412d may instruct the celebrity-content access system 112 to cease display of the timer. At step 806k, the broadcast initiation engine 412i may initiate the scheduled presentation of premium content. In some embodiments, the broadcast initiation engine 412i may provide an instruction to load the premium content into a specified portion of the celebrity channel. As discussed, by linking the initiation of the scheduled presentation of the premium content with expiry of the timer, the broadcast initiation engine 412i may advantageously allow the celebrity-generated content to air only after editors have had time to determine whether the premium content is consistent with the celebrity's image. Further, by tightly coupling the initiation of the premium content broadcast with expiry of the timer, the broadcast initiation engine 412i may further protect the brand and/or privacy of a celebrity.

Although FIG. 8B shows steps 806h and 806i as occurring after step 806g, it is noted that steps 806h and 806i may occur anywhere in the method 806. For instance, in some embodiments, the access rights engine 412h may offer the target audience an option to purchase the celebrity-generated content and/or select fans with access rights after the broadcast information engine 412a receives notification of the scheduled presentation of premium content or after the timer control engine 412d initiates the timer. In various embodiments, the access rights engine 412h may iteratively offer the target audience an option to purchase the celebrity-generated content and/or select fans with access rights at various times during the pendency of the timer. In some embodiments, the cost of the content may go up as the timer continues. For instance, the access rights engine 412h may offer the target audience an option to purchase the celebrity-generated content at a first price after the broadcast information engine 412a receives notification of the scheduled presentation of premium content, at a second price after the timer control engine 412d initiates the timer, at a third price after expiration warning notification engine 412g provides the expiration notification, and at a fourth price after the timer control engine 412d exits the timer. The first, second, third, and fourth prices may vary based on the importance of selling the premium content at various price points throughout the pendency of the timer. Further, in some embodiments, the presentation of the premium content may occur at a particular time, and need not be coupled to the timer.

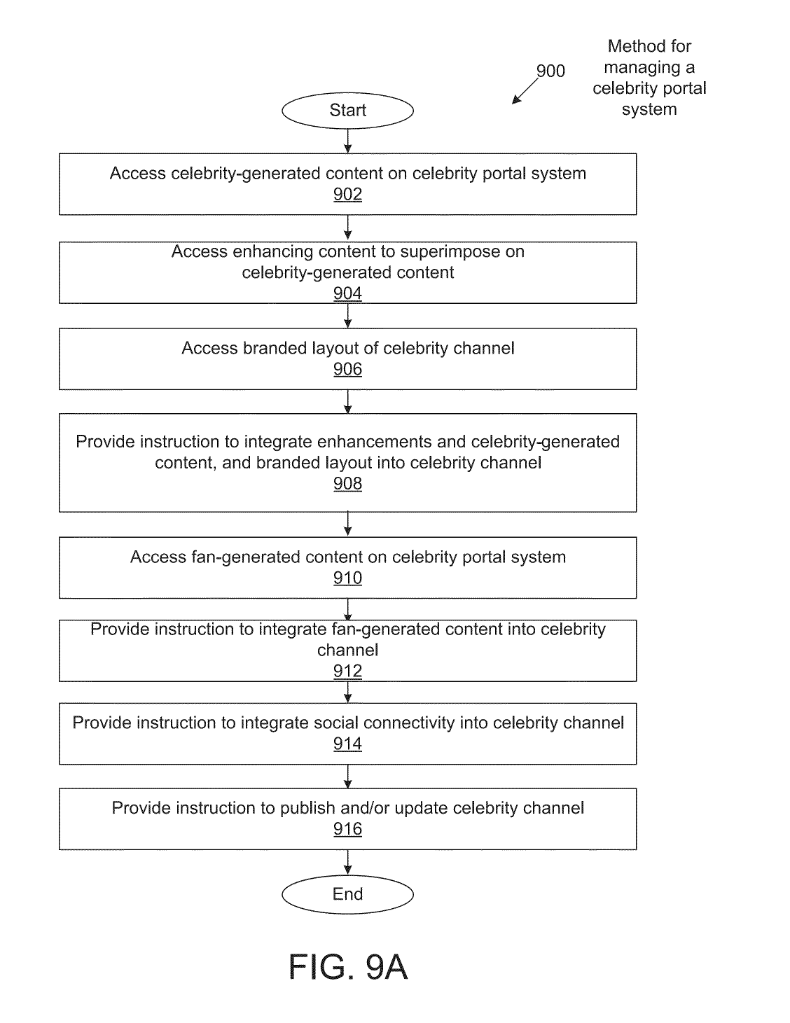

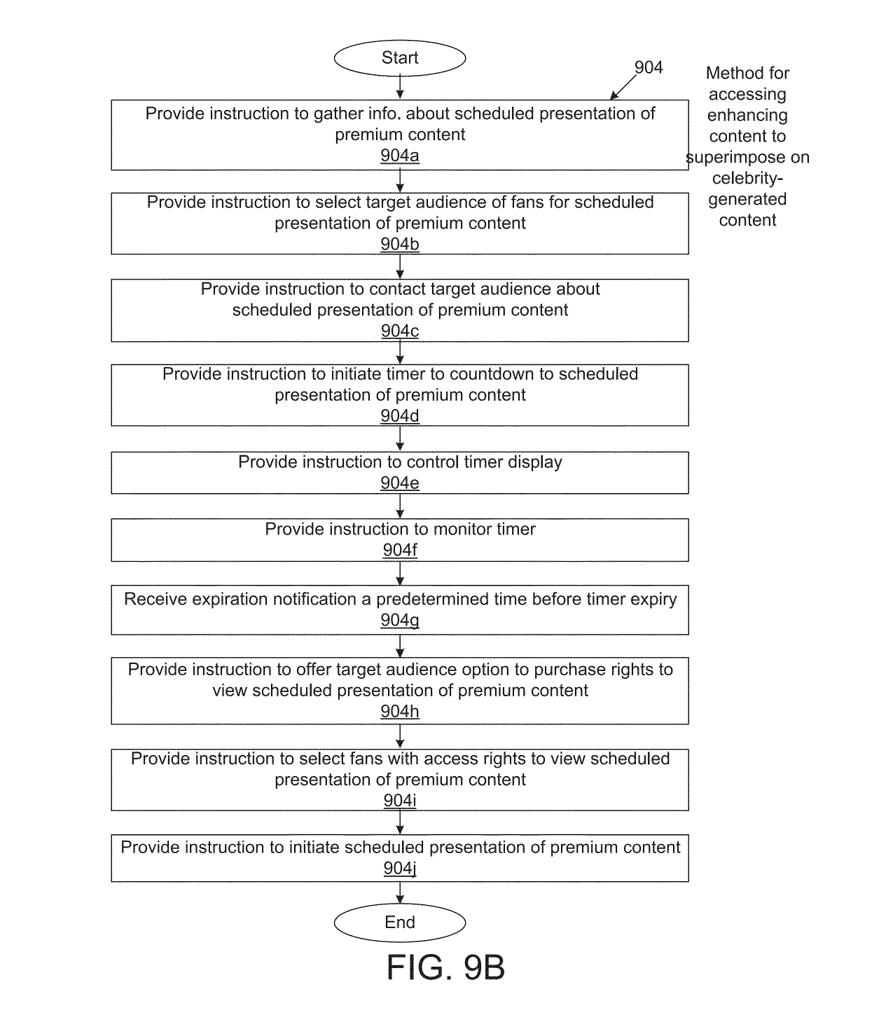

FIG. 9A shows a flowchart of an example of a method 900 for managing a celebrity portal, according to some embodiments. The method 900 is discussed in conjunction with a processor and a memory of the editor system 116 in FIG. 5B. It is noted that other structures may enable the method 900. It is also noted that the method 900 may contain substeps not illustrated, and that it may be possible to perform the inventive concepts shown in the method 900 without executing all of the steps in the method 900.

Step 902 comprises accessing celebrity-generated content on the celebrity portal system. In the example of FIG. 5B, the celebrity content management API engine 518 may be configured to access a specific celebrity account and/or a specific celebrity channel. The access may be based on the celebrity's permissions and/or preferences. The celebrity content access API engine 520 may further access specific items of celebrity-generated content captured by the celebrity. The communications interface 504 may facilitate a connection to the celebrity portal system 114.

At step 904, the content enhancement API engine 522 may access enhancing content to superimpose on the celebrity-generated content. In various embodiments, the content enhancement API engine 522 may provide instructions to apply a set of editing effects, text or animation, deletion of messages, grammatical edits to messages, and/or text added to messages to maximize a celebrity's brand value, among other features. The content enhancement API engine 522 may further provide instructions to provide additional multimedia content or social media from an editor. For instance, the content enhancement API engine 522 may provide instructions to apply videos or images for superimposition on multimedia content and/or social media. In various embodiments, the content enhancement API engine 522 may provide instructions to apply value-added information to celebrity-generated content. In various embodiments, the content enhancement API engine 522 may provide instructions to order portions of the celebrity-generated content into a news feed having a priority. The priority may depend on one or more of a chronological priority, an editor-determined priority, and content popularity/engagement algorithms.

At step 906, the brand management API engine 524 may access a branded layout of the celebrity channel. The brand management API engine 524 may provide instructions to apply branding templates to ensure that a celebrity portal containing celebrity-generated content adequately reflects the brand value of a celebrity.

At step 908, the content integration API engine 528 may provide instructions to integrate the enhancements and the celebrity-generated content into a celebrity channel. At step 910, the fan content management API engine 526 may access fan-generated content on the celebrity portal system 114. More specifically, the fan content management API engine 526 may be configured to provide instructions to indicate which content types fans want, and which items of fan-generated content are to be inserted into the celebrity channel. At step 912, the content integration API engine 528 may provide instructions to integrate fan-generated content into the celebrity channel. At step 914, the content integration API engine 528 may provide instructions to integrate social connectivity into the celebrity channel. At step 916, the content publication API engine 530 may provide instructions to create and/or update the celebrity channel.

FIG. 9B shows a flowchart of an example of a method 904 for accessing enhancing content to superimpose on celebrity-generated content. In some embodiments, the method 904 may correspond to the step 904, shown in FIG. 9A. The method 904 is discussed in conjunction with a processor and a memory of the content enhancement API engine 522 in FIG. 5C. It is noted that other structures may enable the method 904. It is also noted that the method 904 may contain substeps not illustrated, and that it may be possible to perform the inventive concepts shown in the method 904 without executing all of the steps in the method 904.

At step 904a, the broadcast information API engine 522a may provide an instruction to gather information about a scheduled presentation of premium content. At step 904b, the broadcast audience selection API engine 522b may provide an instruction to select a target audience of fans for the scheduled presentation of premium content. At step 904c, the fan contact API engine 522c may provide an instruction to contact the target audience about the scheduled presentation of premium content. At step 904d, the timer control API engine 522d may provide an instruction to initiate a timer to count down to the scheduled presentation of premium content. At step 904e, the timer display control API engine 522e may provide an instruction to control the timer display. At step 904f, the timer monitor API engine 522f may provide an instruction to monitor the timer. At step 904g, the expiration warning notification API engine 522g may receive an expiration notification a predetermined time before the timer expiry. At step 904h, the access rights API engine 522h may provide an instruction to offer the target audience an option to purchase rights to access the scheduled presentation of premium content. At step 904i, the access rights API engine 522h may provide an instruction to select fans with access rights to view the scheduled presentation of premium content. It is noted that the timer may or may not be exited at this time. At step 904j, the broadcast initiation API engine 522i may provide an instruction to initiate the broadcast of the scheduled presentation of premium content.

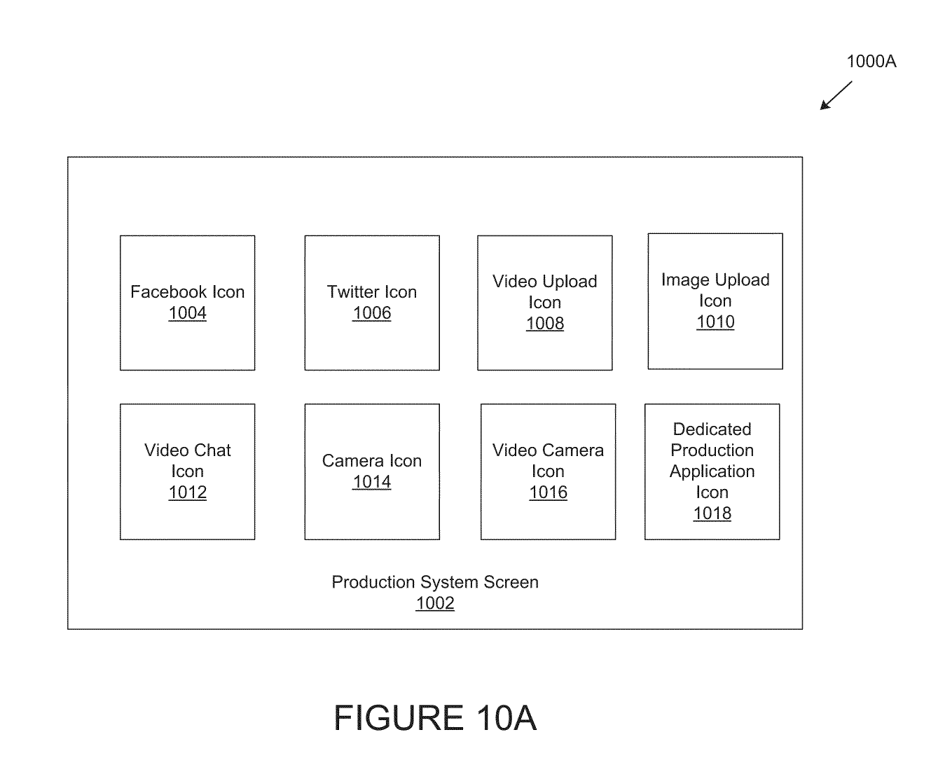

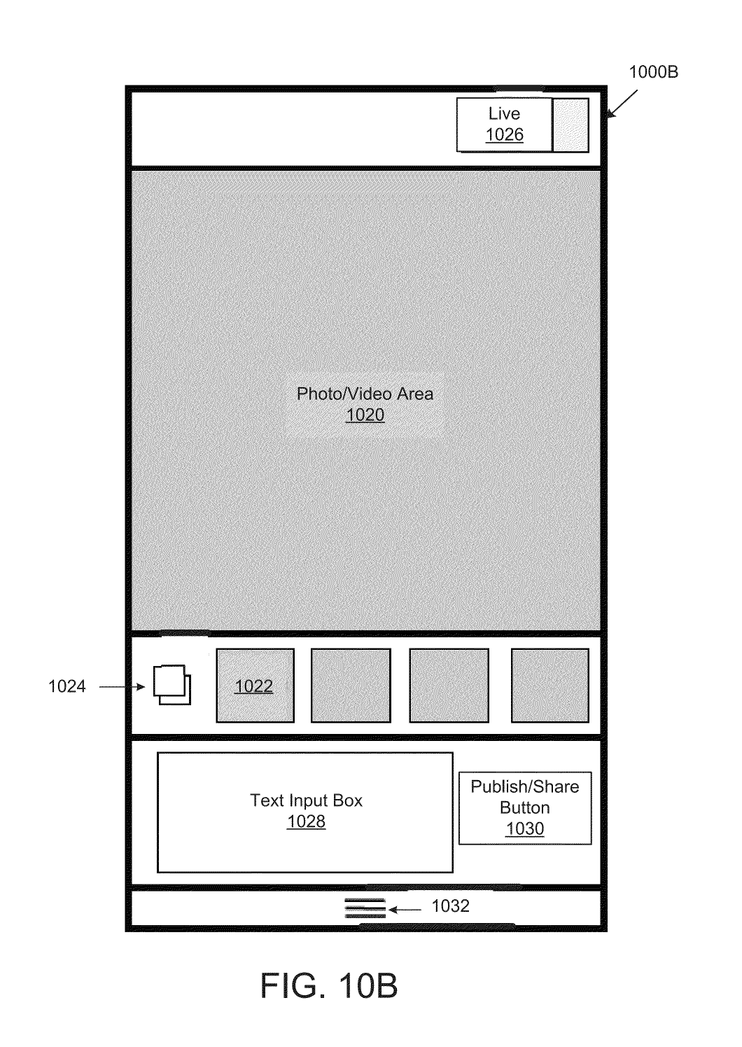

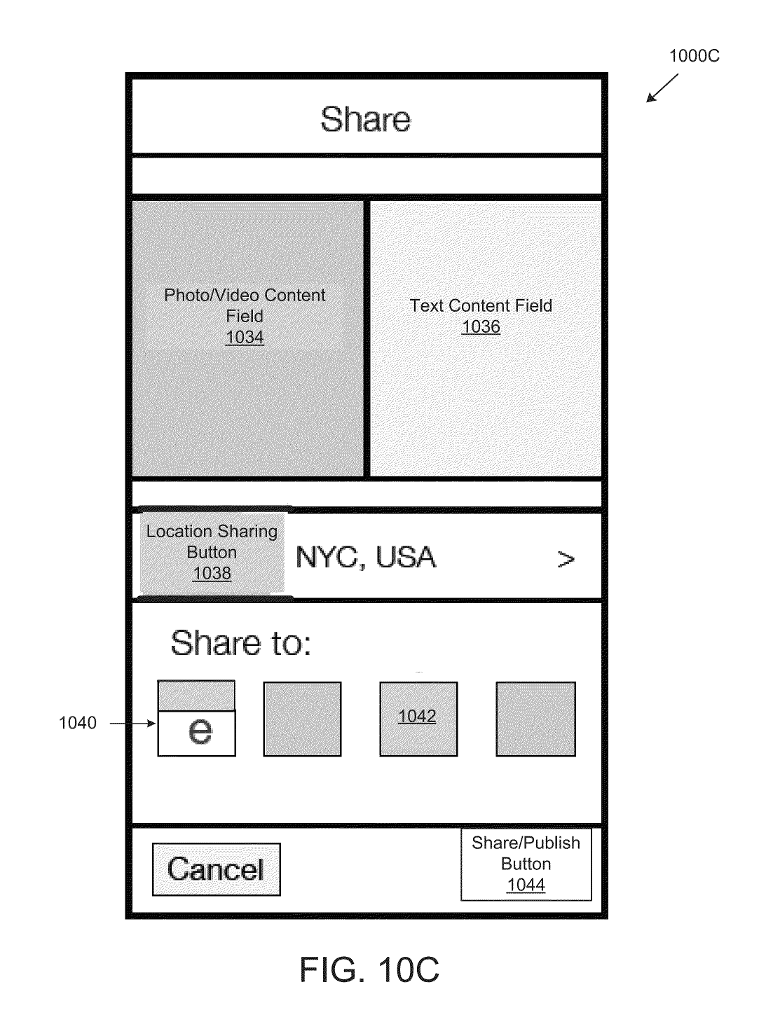

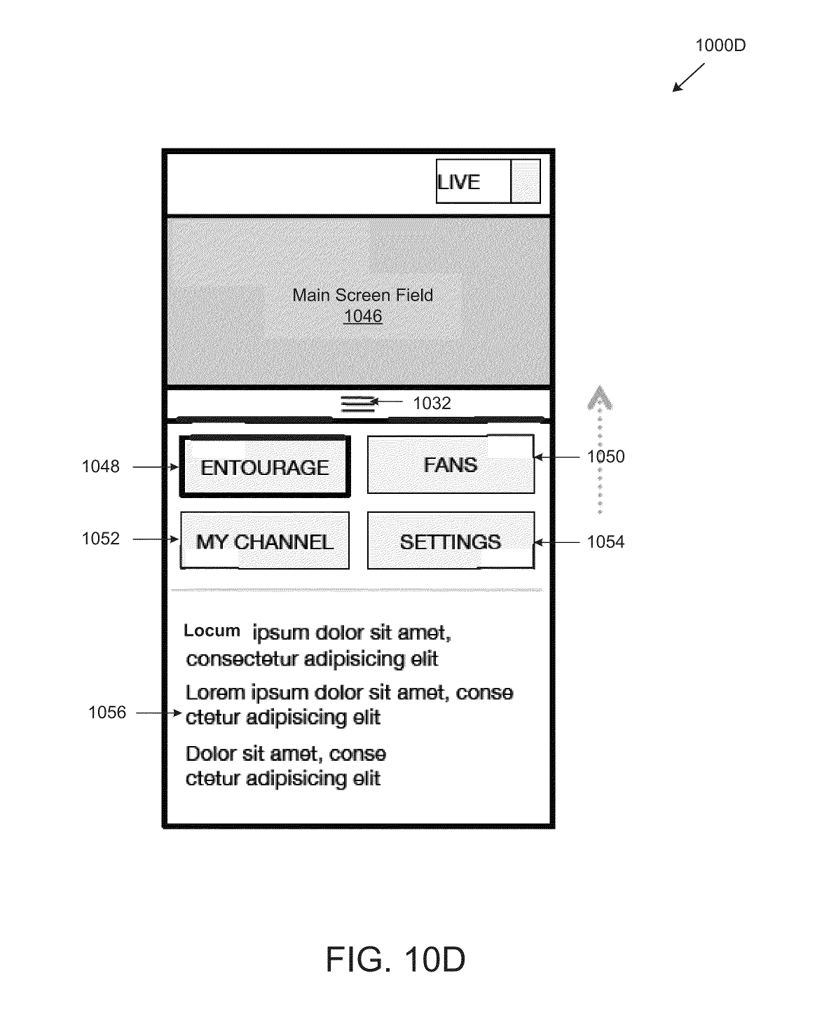

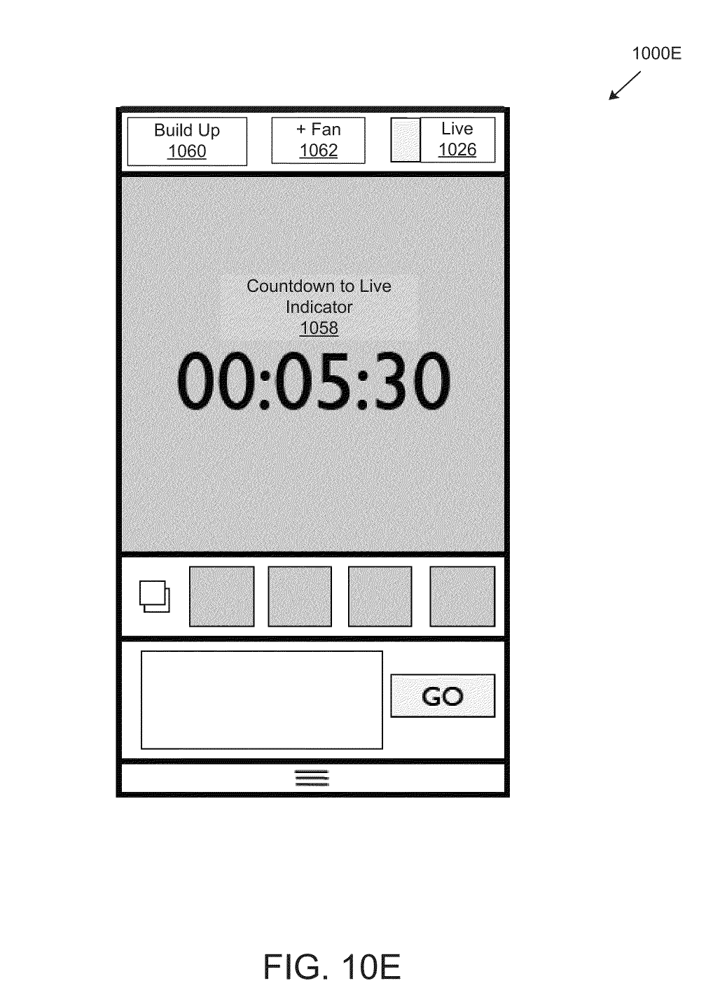

FIG. 10A shows an example of a production system interface 1000A, according to some embodiments. The production system interface 1000A may contain a production system screen 1002. In some embodiments, the production system screen 1002 may represent a screen of a celebrity seeking to use a celebrity portal. The production system interface 1000A may allow a celebrity to create and/or modify celebrity-generated content in at least one of two ways. First, the production system interface 1000A may allow a celebrity to access one or more applications that allow creation of celebrity-generated content without use of celebrity support services. For example, the production system interface 1000A may include a Facebook® icon 1004, a Twitter icon 1006, a video upload icon 1008, an image upload icon 1010, a video chat icon 1012, a camera icon 1014, and a video camera icon 1016. Second, the production system interface 1000A may allow a celebrity to access a dedicated application that allows the creation and/or modification of celebrity-generated content and access to celebrity support services. Namely, the production system interface 1000A may include a dedicated production application icon 1018.

The Facebook® icon 1004 may link the celebrity to a social networking application, here Facebook®. The Twitter icon 1006 may also link the celebrity to a social networking application, here, Twitter®. The video upload icon 1008 may be operative to allow the celebrity to capture and/or upload a video to a celebrity portal. To this end, the video upload icon 1008 may link the celebrity to a video camera (e.g., a webcam or a mobile phone camera) operatively accessible by the production system screen 1002. Once the video camera is active, there may be initiated video capture from the video camera. A network link may provide streaming of captured video to a celebrity portal system. In some embodiments, the video upload icon 1008 may allow the celebrity to upload a saved video to the celebrity portal.

The image upload icon 1010 may be operative to allow the celebrity to capture and/or upload an image to the celebrity portal. To this end, the image upload icon 1010 may link the celebrity to a still camera (e.g., a mobile phone camera) operatively accessible by the production system screen 1002. Once the image camera is active, there may be initiated image capture from the image camera. A network link may provide transmission of captured images to the celebrity portal system. In some embodiments, the image upload icon 1010 may allow the celebrity to upload a saved image to the celebrity portal.

The video chat icon 1012 may be operative to allow initiation of video chat services. The video chat services may be run with the celebrity portal service providers (e.g., a closed video chat system) or run by a third-party video chat service. The camera icon 1014 may be operative to initiate image capture by a camera operatively accessible by the production system screen 1002. The video camera icon 1016 may be operative to initiate video capture by a video camera operatively accessible by the production system screen 1002.

The dedicated production application icon 1018 may be operative to provide a link to a production system allowing a celebrity to create and/or modify celebrity-generated content using one or more of a still camera, a video camera, and a textual input device (e.g., a keyboard or a touchscreen interface) operatively accessible by the production system screen 1002. In various embodiments, the dedicated production application icon 1018 may link the celebrity to the screen shown in FIG. 10B.

FIG. 10B shows an example of a content creation screen 1000B of a dedicated production application, according to some embodiments. The content creation screen 1000B may be the default screen of the dedicated production application. For instance, a celebrity may be taken to the content creation screen 1000B after clicking the dedicated production application icon 1018 in FIG. 10A. The content creation screen 1000B may be configured to be displayed on a mobile device that accepts gesture-based input. Gesture-based input, as used herein, is the transformation of human gestures such as movements of a person's hands, face, or body, into an input of a digital device. Examples of mobile devices that accept gesture-based input include iPhones®, iPads®, Android® phones, Android® tablets, and trackpads and/or mice. As a result, the content creation screen 1000B allows a celebrity to create and publish celebrity-generated content in a simple and intuitive way.

The content creation screen 1000B may include a photo/video area 1020, a content storage area 1022, an archive icon 1024, a live broadcast button 1026, a text input box 1028, a publish/share button 1030, and a service access slider 1032. The photo/video area 1020 may show the output of a camera. In this example, the photo/video area 1020 may display the output of the camera whenever the content creation screen 1000B is active. In some embodiments, the photo/video area 1020 may accept one or more gestures related to image and/or video capture. For instance, the photo/video area 1020 may accept a first gesture that directs the camera to take a photo. The first gesture may involve a simple touch of the photo/video area 1020. The photo/video area 1020 may also accept a second gesture that directs the camera to initiate video recording. The second gesture may involve holding the photo/video area 1020 for a specified duration of time (e.g., approximately two seconds). In some embodiments, the photo/video area 1020 may accept a third gesture that allows for the application of photo and/or video filters. The third gesture may include, for instance, a swipe (e.g., a horizontal swipe) of the screen.

The content storage area 1022 may show a list of images and/or videos that are stored for use by the dedicated production application. The images and/or videos may be stored locally on the mobile device or on a celebrity portal system. The archive icon 1024 may link the celebrity to archived images and/or videos. The live broadcast button 1026 may allow the celebrity to toggle to and from a live mode to permit a broadcast of premium content. As discussed, a live mode may allow the celebrity to perform a live broadcast of the video captured by the camera. The text input box 1028 may allow the celebrity to input text into the dedicated production application. The publish/share button 1030 may allow the celebrity to publish celebrity-generated content created by the dedicated production application. In various embodiments, the publish/share button 1030 may link the celebrity to the screen shown in FIG. 10C. The service access slider 1032 may allow the celebrity to access celebrity supports services. In various embodiments, the service access slider 1032 may link the celebrity to the screen shown in FIG. 10D.

FIG. 10C shows an example of a publish/share screen 1000C of a dedicated production application, according to some embodiments. The publish/share screen 1000C may be the screen a celebrity sees when he or she instructs the dedicated production application to publish celebrity-generated content. In some embodiments, a celebrity may be directed to the publish/share screen 1000C after clicking the publish/share button 1030 in FIG. 10B. The publish/share screen 1000C may implement gesture-based input to ensure that users can create celebrity-generated content without unnecessary effort.

The publish/share screen 1000C may include a photo/video content field 1034, a text content field 1036, a location sharing button 1038, an enhancement request button 1040, a social platform sharing button 1042, and a share/publish button 1044. The photo/video content field 1034 may represent images and/or video a celebrity desires to provide to a celebrity portal. The text content field 1036 may include text associated with the images and/or video. The location sharing button 1038 may indicate a broad posting of a geographical position of the celebrity. In various embodiments, the location sharing button 1038 may be linked to a geography-based transmitter (e.g., a global positioning system (GPS) transmitter).

The enhancement request button 1040 may allow the celebrity to send celebrity-generated content to an editor for enhancements. In some embodiments, the enhancement request button 1040 may change the dedicated production application from a live publication mode to a delayed publication mode. In the delayed publication mode, the dedicated production application may notify editors to enhance the content and/or circulate enhanced content. The circulation of the enhanced content may occur at a predetermined time or on a schedule. In some embodiments, the delayed publication mode may be enabled as a default to protect the brand and/or reputation of celebrities. In various embodiments, users may be given the option to enable the delayed publication mode on a post-by-post basis. In the example of FIG. 10C, the social platform sharing button 1042 may allow the celebrity to share celebrity-generated content using social media. The share/publish button 1044 may allow the celebrity to share and/or publish the celebrity-generated content.

FIG. 10D shows an example of a celebrity support services screen 1000D of a dedicated production application, according to some embodiments. The celebrity support services screen 1000D may be the screen a celebrity sees when he or she requests celebrity support services. In some embodiments, the celebrity may be directed to the celebrity support services screen 1000D after sliding the service access slider 1032 (also shown in FIG. 10B, and indicated generally by an arrow). The celebrity support services screen 1000D may include a main screen field 1046, a feedback service button 1048, a fan information button 1050, a channel information button 1052, a settings button 1054, and a notifications area 1056. The main screen field 1046 may show the area of the dedicated production application that is visible after the service access slider 1032 has been moved up. In this example, the feedback service button 1048 may include information from data-driven feedback services, editorially driven feedback services, and/or concierge services. The fan information button 1050 may provide information relating to fans of a celebrity. The channel information button 1052 may provide information relating to the celebrity's channel. In this example, the settings button 1054 may provide settings related to the dedicated production application. Further, the notifications area 1056 may provide notifications relating to celebrity support services.

FIG. 10E shows an example of a countdown to live broadcast screen 1000E of a dedicated production application, according to some embodiments. The countdown to live broadcast screen 1000E may be the screen a celebrity sees when the celebrity is about to begin broadcasting premium content (here a live broadcast from the celebrity's mobile device). In some embodiments, the celebrity may be directed to the countdown to live broadcast screen 1000E after toggling the live broadcast button 1026 in FIG. 10B. The countdown to live broadcast screen 1000E may include a countdown indicator 1058, a build up button 1060, an add fan button 1062, and the live broadcast button 1026. The countdown indicator 1058 may display a timer to count down to the scheduled presentation of premium content. The build up button 1060 may allow a celebrity to set a countdown time. The build up button 1060 may also allow a celebrity to trigger automated fan notifications. More specifically, in some embodiments, the build up button 1060 may allow the celebrity to notify fans and/or editors of the upcoming scheduled presentation of premium content. The add fan button 1062 may allow the celebrity to add fans to view the premium content. The live broadcast button 1026 may allow the celebrity to toggle out of the live broadcast mode.

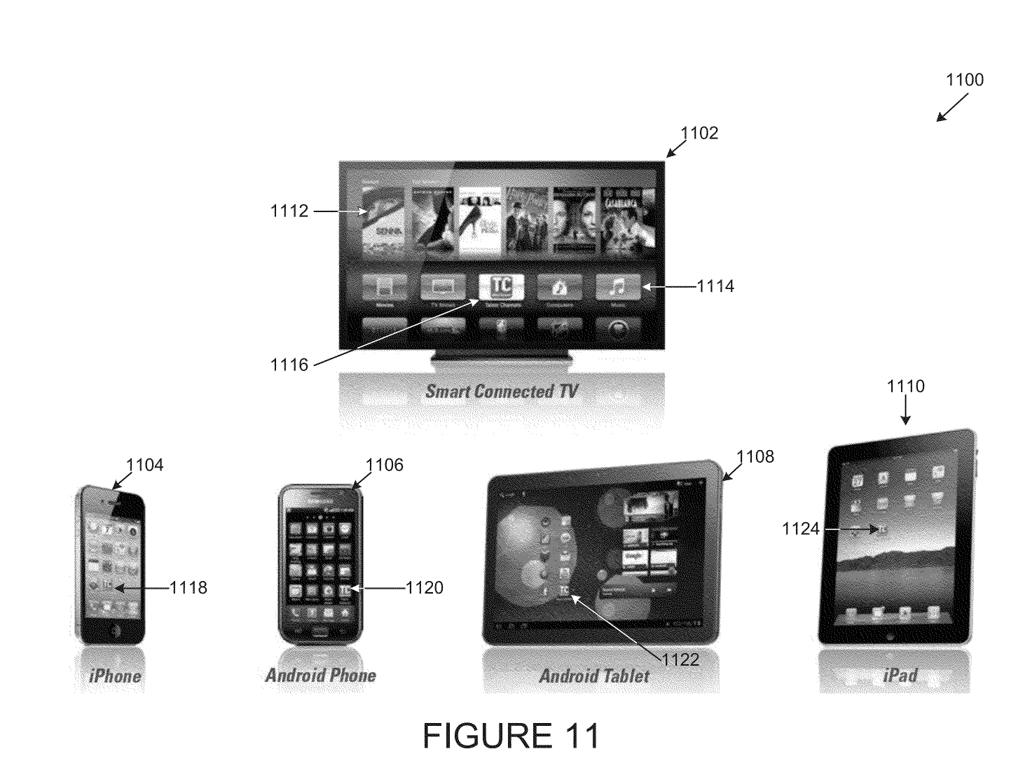

FIG. 11 shows an example of a plurality of digital devices 1100. In the example of FIG. 11, the plurality of digital devices 1100 may contain a networked set-top box 1102, an iPhone® 1104, an Android® phone 1106, an Android® tablet 1108, and an iPad® 1110. Each of the networked set-top box 1102, the iPhone® 1104, the Android® phone 1106, the Android® tablet 1108, and the iPad® 1110 may be configured to display channel access applications. More specifically, the networked set-top box 1102 may be configured to display a movie channel access application 1112, a music channel access application 1114, and a celebrity-content channel access application 1116. The celebrity-content channel access application 1116 allows a fan to access a celebrity portal from the networked set-top box 1102. Similarly, the iPhone® 1104 may include a celebrity-content channel access application 1118, which allows a fan to access the celebrity portal from the iPhone® 1104. The Android® phone 1106 may include a celebrity-content channel access application 1120, which allows a fan to access the celebrity portal from the Android® phone 1106. The Android® tablet 1108 may include a celebrity-content channel access application 1122, which allows a fan to access the celebrity portal from the Android® tablet 1108. In this example, the iPad® 1110 may include a celebrity-content channel access application 1124, which allows a fan to access the celebrity portal from the iPad® 1110. In this example, the celebrity-content channel access applications 1116, 1118, 1120, 1122, and 1124 are shown linking a fan to one or more celebrities. In various embodiments, one or more of the celebrity-content channel access application 1116, 1118, 1120, 1122, and 1124 may correspond to individual celebrities.

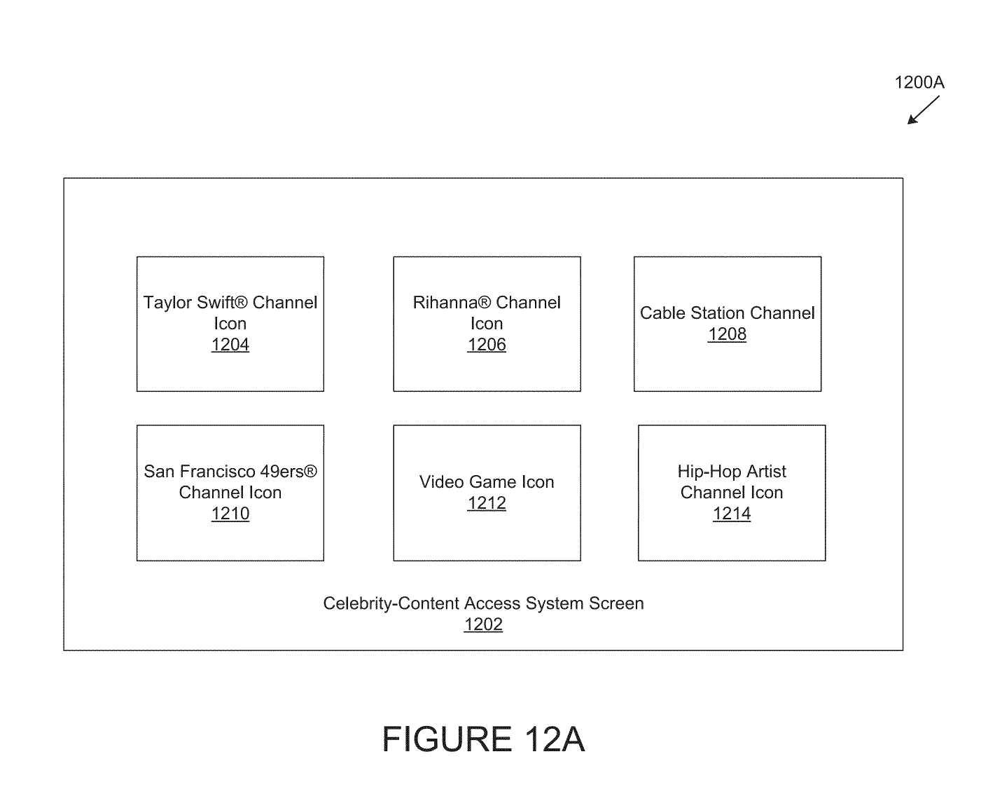

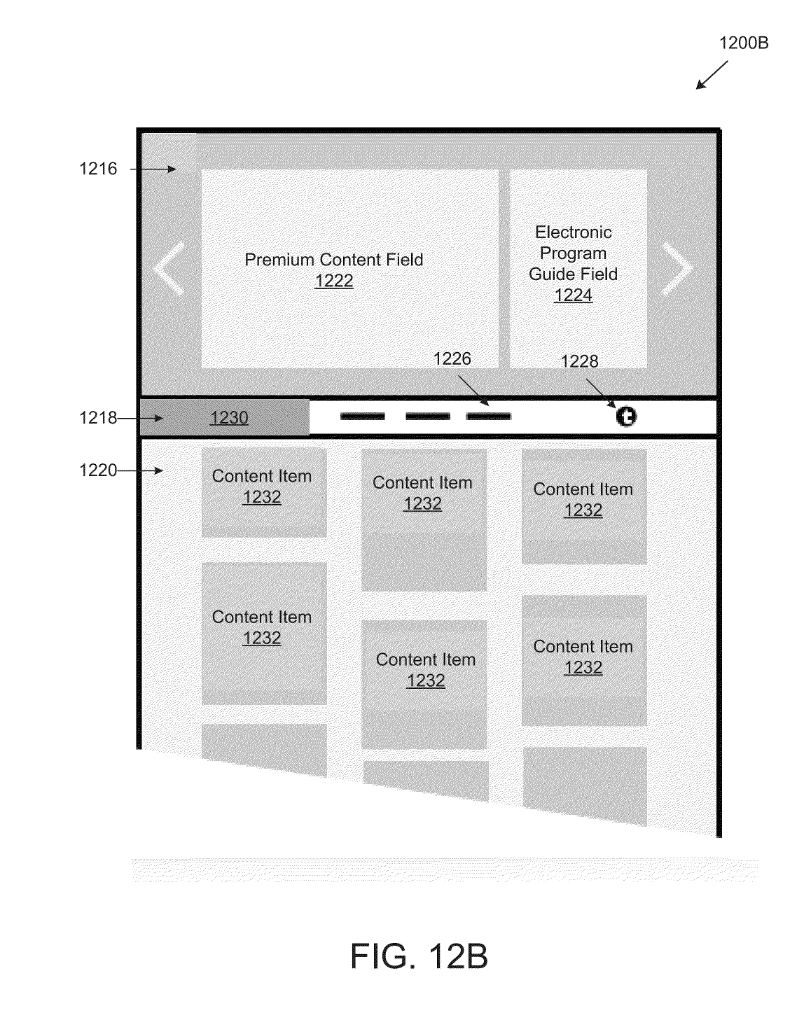

FIG. 12A shows an example of a channel access interface 1200A, according to some embodiments. The channel access interface 1200A may contain a homepage 1202. The homepage 1202 may represent a screen that enables a fan to select one or more channels, including one or more celebrity channels. The homepage 1202 may be the homepage of a mobile device, a networked set-top box, a standalone computer application, or a web browser. One or more of the icons on the homepage 1202 may link the fan to a container application, such as a mobile application, an application on a networked set-top box, a standalone computer application, or a web browser. In this example, the homepage 1202 may include a Taylor Swift® channel icon 1204, a Rihanna® channel icon 1206, a cable station channel icon 1208, a San Francisco 49ers® Channel Icon 1210, a video game icon 1212, and a hip-hop artist channel icon 1214. The Taylor Swift® channel icon 1204 may provide a celebrity channel related to Taylor Swift®. The Rihanna® channel icon 1206 may provide a celebrity channel related to Rihanna®. The cable station channel icon 1208 may provide a link to a cable network channel such as the Cable News Network (CNN). The San Francisco 49ers® Channel Icon 1210 may provide a link to a celebrity channel related to the professional football team, the San Francisco 49ers®. The video game icon 1212 may provide a link to a video game. The hip-hop artist channel icon 1214 may provide a celebrity channel related to a hip-hop artist or a group of hip-hop artists.

FIG. 12B shows an example a celebrity content channel interface 1200B, according to some embodiments. The celebrity content channel interface 1200B may be displayed when a fan clicks on a celebrity content channel icon (e.g., one of the Taylor Swift® channel icon 1204, the Rihanna® channel icon 1206, the San Francisco 49ers® Channel icon 1210, and the hip-hop artist channel icon 1214 in FIG. 12A). The celebrity content channel interface 1200B may include a display for integrating a reactive region 1216, a navigation area 1218, and an interactive region 1220. The reactive region 1216 may comprise content that a fan can view with little or no interactive input. In this example, the reactive region 1216 may include a premium content field 1222 and an electronic program guide field 1224. The premium content field 1222 may display premium and/or branded content and features. The electronic program guide field 1224 may display a navigation tool for the discovery and/or consumption of the premium and/or branded content. The electronic program guide field 1224 may include one or more of a fully branded area of content, key promotions, live streams, competitions, and other content. In some embodiments, the reactive region 1216 can be browsed horizontally to consume premium content. In various embodiments, vertically scrolling the celebrity content channel interface 1200B may collapse areas below the reactive region 1216 but may still render visible the reactive region 1216.

The navigation area 1218 may comprise content filters 1226, a social media icon 1228, and a platform navigation area 1230. The content filters 1226 may filter the material in the interactive region 1220 by content types, content topics, and other information (e.g., cobranded content). The social media icon 1228 may link the material on the celebrity content channel interface 1200B with social media. The platform navigation area 1230 may provide platform navigation, including access to a user profile of a fan, settings, and registration procedures.

The interactive region 1220 may include content items 1232. Content items 1232 may include celebrity-generated content, editor-generated content, and/or fan-generated content. Examples of content items 1232 may include video, photos, text, polls/competitions, fan content, and/or ads. On clicking one or more of the content items 1232, there may be shown options to favorite, comment on, and/or share the one or more content items.

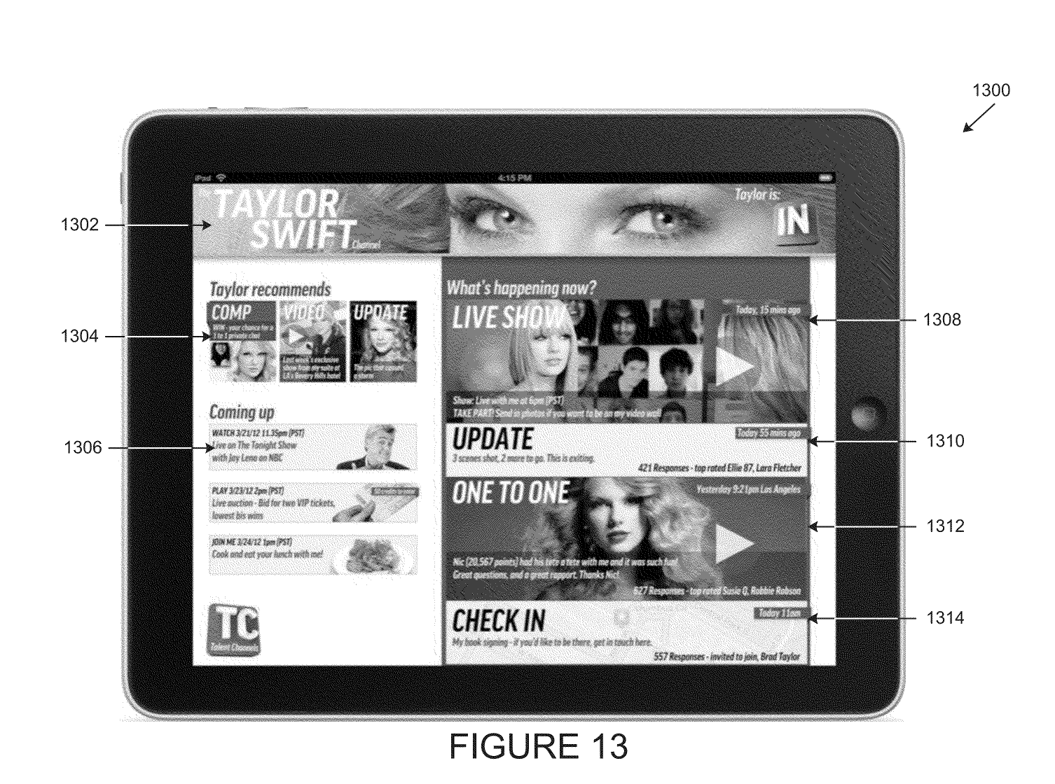

FIG. 13 shows an example of the Taylor Swift® channel interface 1300, according to some embodiments. The Taylor Swift® channel interface 1300 may be accessed by a fan. In this example, the fan has clicked the Taylor Swift® channel icon 1204, shown in FIG. 12A, to open up a celebrity channel related to the country star Taylor Swift®. The Taylor Swift® channel interface 1300 may include a title 1302, a recommendation area 1304, a news feed 1306, a live show notification 1308, an update section 1310, a video chat link 1312, and an event check-in link 1314.

The title 1302 may display information relating to the general content of the celebrity channel. In this example, the title 1302 contains a portion of a headshot of the country star Taylor Swift. The title 1302 may have been professionally edited by an editor. The recommendation area 1304 may display media or causes recommended by Taylor Swift. As shown herein, the recommendation area 1304 may include books, websites, or media that Taylor Swift has found interesting or wishes to recommend to fans. The recommendation area 1304 may have been celebrity-generated, that is, generated by Taylor Swift herself. The news feed 1306 may show upcoming news related to Taylor Swift, including televised appearances. The news feed 1306 may have been generated by an editor system. The live show notification 1308 may provide information about upcoming live shows. The update section 1310 may display updates to the celebrity channel. The video chat link 1312 may display a link to a video chat service allowing fans to chat with Taylor Swift or fans to witness Taylor Swift chatting with another celebrity. The event check-in link 1314 may allow fans to check into locations relevant to Taylor Swift or her brand/image.

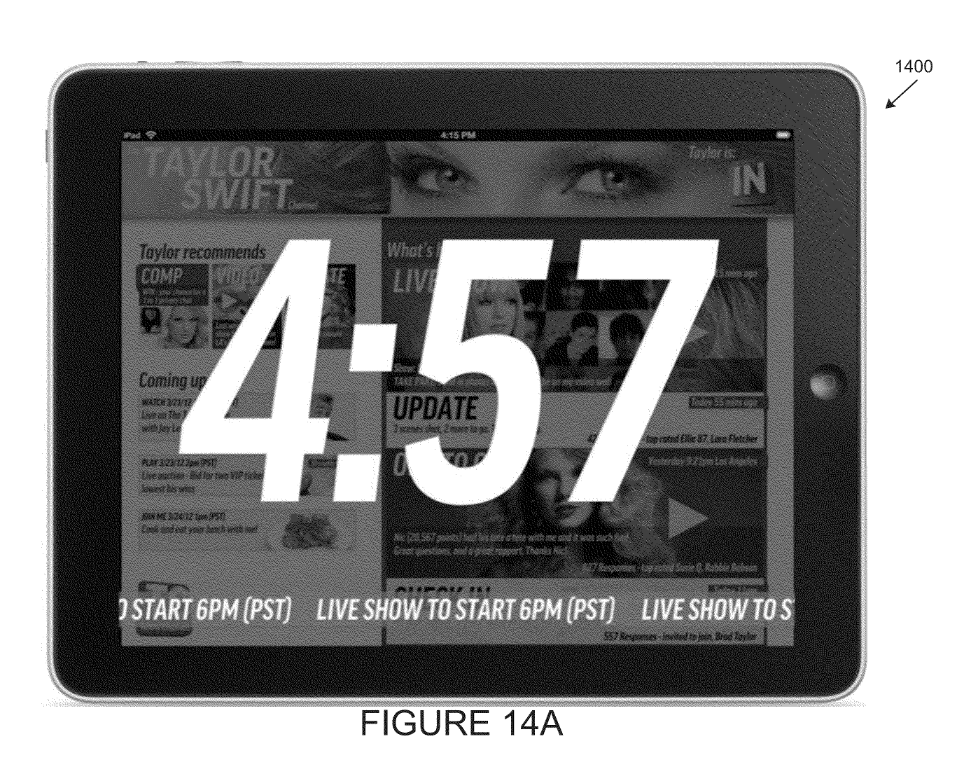

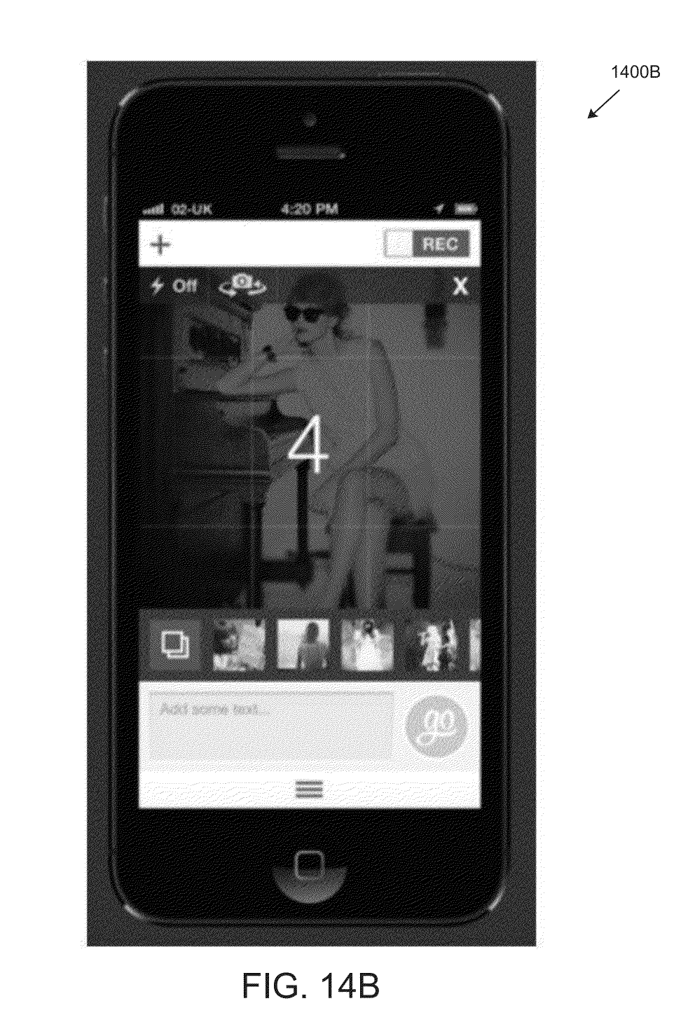

FIG. 14A shows an example of an enhanced celebrity-content interface 1400A, according to some embodiments. The enhanced celebrity-content interface 1400A may contain a countdown to a scheduled presentation of premium content. In this example, the countdown has overridden the content that was displayed on FIG. 13. The enhanced celebrity-content interface 1400A shows that four minutes and fifty seven seconds remain to a scheduled presentation of premium content by Taylor Swift. FIG. 14B shows an example of a countdown to a live broadcast of an enhanced celebrity-content interface 1400B, according to some embodiments. The enhanced celebrity-content interface 1400B may contain a countdown to a scheduled presentation of premium content. The enhanced celebrity-content interface 1400B shows that four seconds remain to a scheduled presentation of premium content by Taylor Swift.

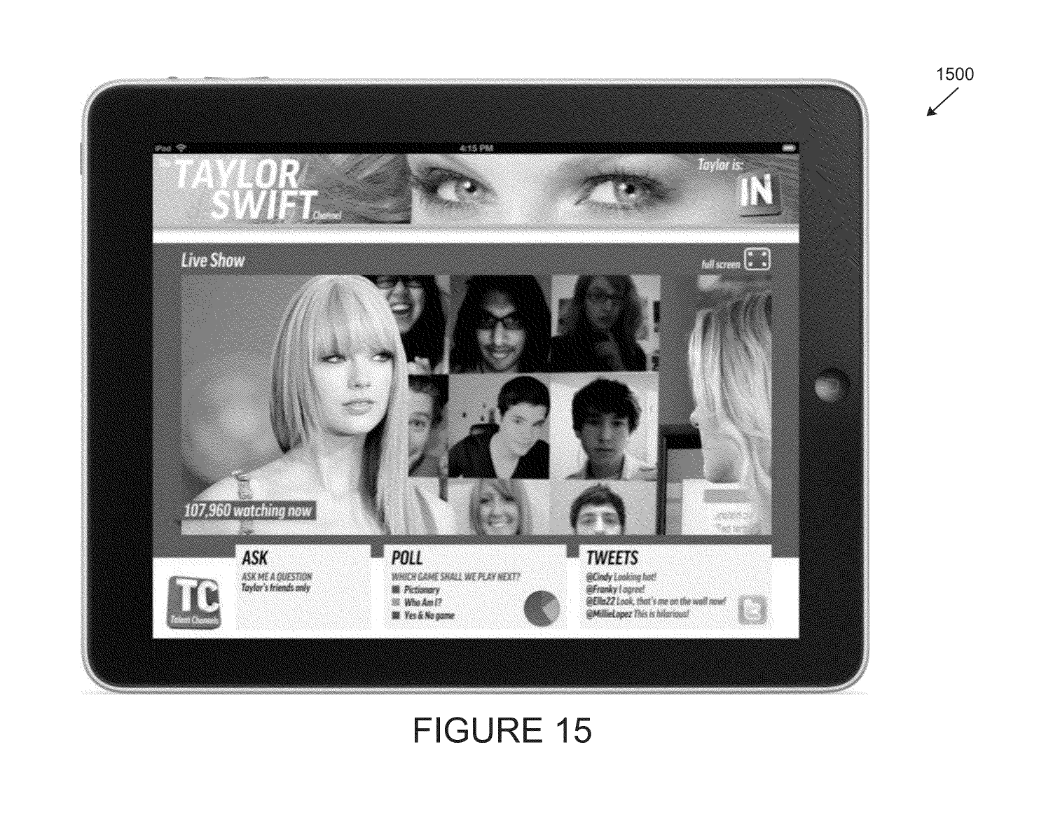

FIG. 15 shows an example of a live celebrity-content interface 1500, according to some embodiments. The live celebrity-content interface 1500 may result from clicking the live show notification 1308 in FIG. 13. The live celebrity-content interface 1500 depicts a live show that is underway. In the live celebrity-content interface 1500, Taylor Swift is talking to a hostess. The format of the interactive live show may vary, and the hostess may be a professional hostess or may be an amateur hostess (e.g., a fan interested in interviewing Taylor Swift). Numerous fans are watching Taylor Swift answer questions from the hostess via video-chat. In various embodiments, the video chat session may be captured by a device as simple as Taylor Swift's webcam, or by a complicated array of professional video capture and production devices. In this example, Taylor Swift can interactively engage her fans in a way not possible by traditional broadcast television or traditional networked media. For instance, fans may use an ask button to submit questions that Taylor Swift can answer. Taylor Swift may direct specific answers to specific fans or groups of fans. Fans may be polled about the games to interactively play. Social media feeds run through the veins of the interactive live show.

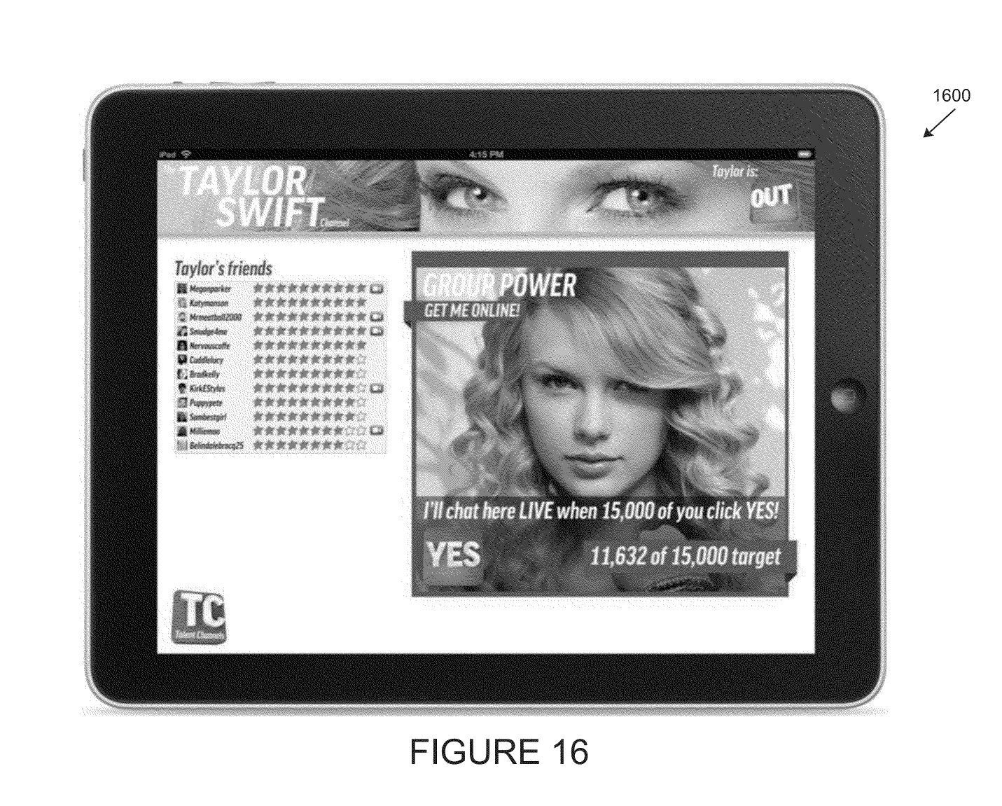

FIG. 16 shows an example of a social media celebrity-content interface 1600, according to some embodiments. The social media celebrity-content interface 1600 shows a set of friend to whom Taylor Swift is connected via social media. The social media celebrity-content interface 1600 also shows a link to fans who may vote to get Taylor Swift online. In this example, Taylor Swift will get online and, e.g., IM or video-chat with fans once 15,000 fans click yes on the voting tab. The social media celebrity-content interface 1600 can allow Taylor Swift to interactively engage her fans in a way not possible by traditional broadcast television or traditional networked media.

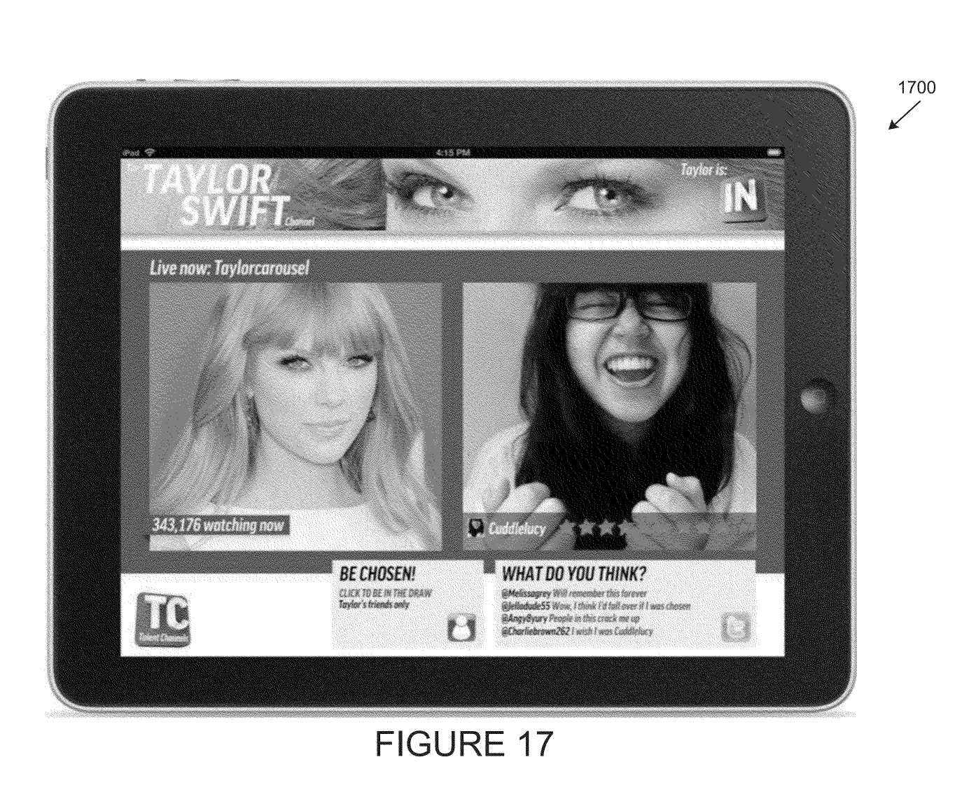

FIG. 17 shows an example of a video chat celebrity-content interface 1700, according to some embodiments. The video chat celebrity-content interface 1700 may result from clicking the video chat link 1312 in FIG. 13. The video chat celebrity-content interface 1700 shows a rotating chat room labeled a “Taylorcarousel.” In this example, Taylor Swift is chatting with an ecstatic fan. The fan has a specified amount of time to directly engage with Taylor Swift. Three hundred thousand one hundred seventy six fans are watching the video-chat session, and the ecstatic fan herself is a celebrity albeit for only several minutes. The video chat celebrity-content interface 1700 further shows a drawing to chat with Taylor Swift and social media polls related to her celebrity.

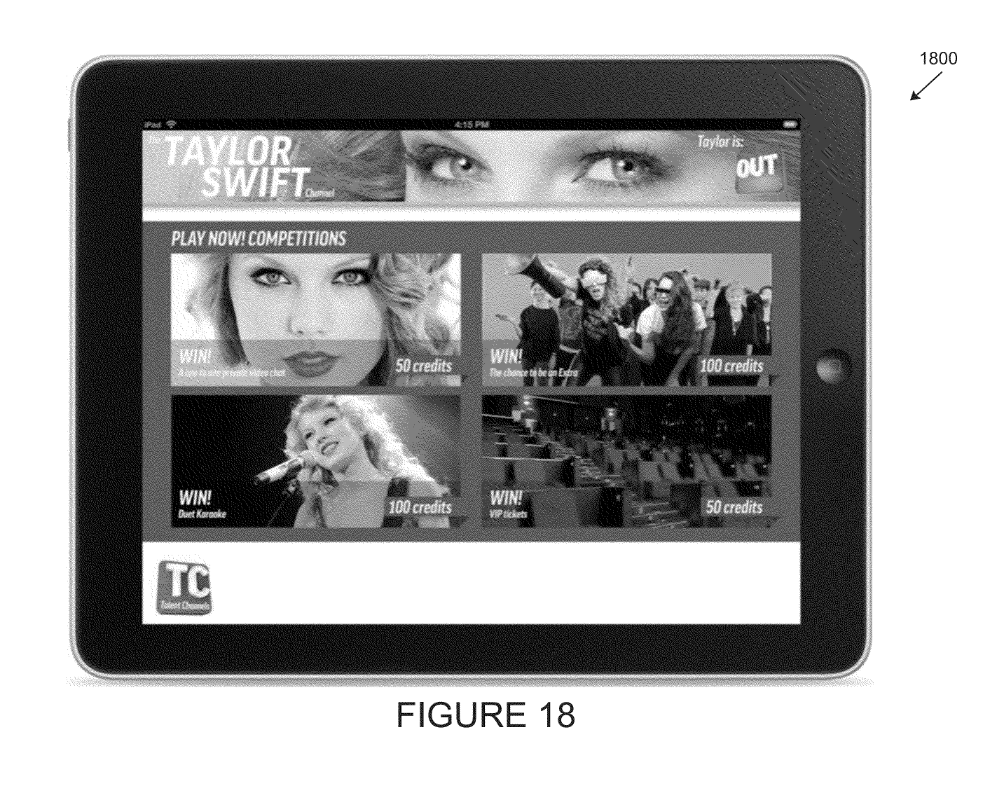

FIG. 18 shows an example of a video game celebrity-content interface 1800, according to some embodiments. The video game celebrity-content interface 1800 shows four video game competitions related to Taylor Swift. In this example, the four video game competitions are integrated into a portal related to Taylor Swift. As a result, the makers of the four video games have greater market penetration into Taylor Swift's fan base than previously possible.

FIG. 19 shows an example of a digital device 1900, according to some embodiments. In the example of FIG. 19, the digital device 1900 may be a conventional digital device that may be used as a client digital device, such as a wireless client or a workstation, or a server digital device. The digital device 1900 includes a computer 1902, I/O devices 1904, and a display device 1906. The computer 1902 includes a processor 1908, a communications interface 1910, memory 1912, display controller 1914, non-volatile storage 1916, and I/O controller 1918. The computer 1902 may be coupled to or include the I/O devices 1904 and display device 1906.

The computer 1902 interfaces to external systems through the communications interface 1910, which may include a modem or network interface. It will be appreciated that the communications interface 1910 may be considered to be part of the digital device 1900 or a part of the computer 1902. The communications interface 1910 may be an analog modem, ISDN modem, cable modem, token ring interface, satellite transmission interface (e.g. “direct PC”), or other interfaces for coupling a digital device to other digital devices.

The processor 1908 may be, for example, a conventional microprocessor such as an Intel Pentium microprocessor or Motorola power PC microprocessor. The memory 1912 is coupled to the processor 1908 by a bus 1920. The memory 1912 may be Dynamic Random Access Memory (DRAM) and may also include Static RAM (SRAM). The bus 1920 couples the processor 1908 to the memory 1912, also to the non-volatile storage 1916, to the display controller 1914, and to the I/O controller 1918.

The I/O devices 1904 may include a keyboard, disk drives, printers, a scanner, and other input and output devices, including a mouse or other pointing device. The display controller 1914 may control in the conventional manner a display on the display device 1906, which may be, for example, a cathode ray tube (CRT) or liquid crystal display (LCD). The display controller 1914 and the I/O controller 1918 may be implemented with conventional well known technology.

The non-volatile storage 1916 is often a magnetic hard disk, an optical disk, or another form of storage for large amounts of data. Some of this data is often written, by a direct memory access process, into memory 1912 during execution of software in the computer 1902. One of skill in the art will immediately recognize that the terms “machine-readable medium” or “computer-readable medium” includes any type of storage device that is accessible by the processor 1908 and also encompasses a carrier wave that encodes a data signal.

The digital device 1900 is one example of many possible digital devices which have different architectures. For example, personal computers based on an Intel microprocessor often have multiple buses, one of which may be an I/O bus for the peripherals and one that directly connects the processor 1908 and the memory 1912 (often referred to as a memory bus). The buses are connected together through bridge components that perform any necessary translation due to differing bus protocols.

Network computers are another type of digital device that may be used in conjunction with the teachings provided herein. Network computers do not usually include a hard disk or other mass storage, and the executable programs are loaded from a network connection into the memory 1912 for execution by the processor 1908. A Web TV system, which is known in the art, is also considered to be a digital device, but it may lack some of the features shown in FIG. 19, such as certain input or output devices. A typical digital device will usually include at least a processor, memory, and a bus coupling the memory to the processor.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a digital device, or similar electronic computing device, that manipulates and transforms data represented as physical (electronic) quantities within the digital device's registers and memories into other data similarly represented as physical quantities within the digital device memories or registers or other such information storage, transmission or display devices.

Techniques described in this paper relate to apparatus for performing the operations. The apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a digital device bus.

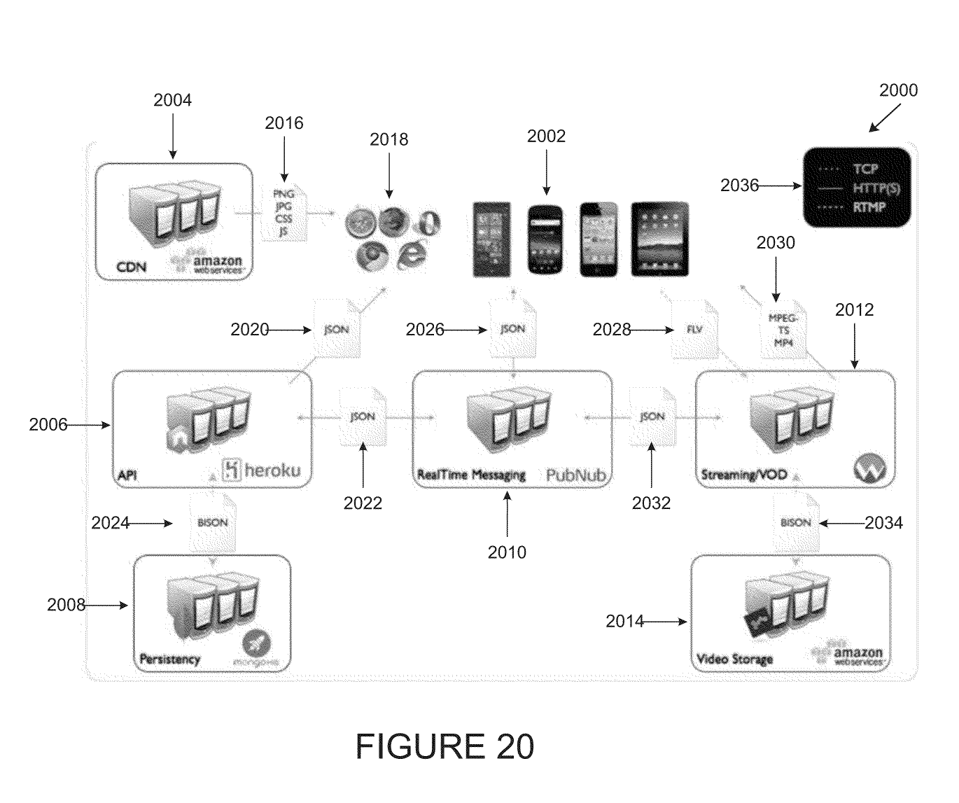

FIG. 20 shows an example of a technology platform 2000 for implementing a celebrity portal, according to some embodiments. The technology platform 2000 shows possible ways to implement portions of the inventive concepts described herein. The technology platform 2000 may include end user devices 2002, content delivery servers 2004, API servers 2006, persistency servers 2008, messaging servers 2010, streaming content servers 2012, and content storage servers 2014. The technology platform 2000 may further include content modules 2016, container applications 2018, Javascript object modules 2020, Javascript object modules 2022, parsing modules 2024, Javascript object modules 2026, flash video modules 2028, video content modules 2030, Javascript object modules 2032, parsing modules 2034, and transport channels 2036.

The end user devices 2002 may include one or more digital devices configured to generate and/or view content. In some embodiments, the end user devices 2002 may include a networked set-top box, a mobile phone, a tablet, a desktop computer, or other device. The end user devices 2002 may comprise a celebrity device, a fan device, and an editor device. The end user devices 2002 may be configured to execute the container applications 2018. The content delivery servers 2004 may include a set of digital devices configured to deliver content to the end user devices 2002. In this example, the content delivery servers 2004 may be configured to deliver the content modules 2016 to the container applications 2018 via a Hypertext Transfer Protocol Secure (HTTPS) transport channel. The API servers 2006 may be configured to deliver the Javascript object modules 2020 to the container applications 2018 through an HTTPS transport channel, and to deliver the Javascript object modules 2022 to the messaging servers 2010 through an HTTPS transport channel. The API servers 2006 may be configured to supply the messaging servers 2010 with the Javascript object modules 2022 via an HTTPS transport channel. In this example, the persistency servers 2008 may be configured to supply the API servers 2006 with parsing modules 2024 through a Transmission Control Protocol (TCP) transport channel. The messaging servers 2010 may be configured to supply the API servers 2006 with Javascript object modules 2022 and the streaming content servers 2012 with Javascript object modules 2032 through HTTPS transport channels.

The streaming content servers 2012 may be configured to provide the end user devices with flash video modules 2028 through a Real Time Messaging Protocol (RTMP) transport channel and with video content modules 2030 through an HTTPS transport channel. The streaming content servers 2012 and the content storage servers 2014 may be configured to supply one another with parsing modules 2034 via an HTTPS transport channel.

We claim:

1. A celebrity portal system comprising:
a celebrity content management engine for managing a celebrity portal, the celebrity portal including media content based on real-time multimedia content generated by a particular celebrity and available for consumption by fans;
a broadcast information engine for receiving notice of a scheduled presentation of premium content on the celebrity portal;
a fan contact engine for notifying a set of the fans of the scheduled presentation of the premium content on the celebrity portal; and
a content publication engine for publishing the premium content in the celebrity portal.

2. The system of claim 1 wherein the fan contact engine is configured to notify the set of the fans using multiple contact methods.

3. The system of claim 1 wherein the premium content includes at least a portion of the real-time multimedia content.

4. The system of claim 1 wherein the premium content comprises pay-per-view content.

5. The system of claim 1 further comprising a timer control engine for providing the set of fans with a timer configured count down to the premium content.

6. The system of claim 5 further comprising an expiration warning notification engine for providing an expiration notification of the timer a predetermined time before expiration of the timer.

7. The system of claim 1 further comprising an access rights engine for selecting at least a portion of the set of fans to view the premium content based on access rights of the least a portion of the set of fans.

8. The system of claim 7 wherein the access rights engine is configured to offer the set of fans an option to purchase the premium content.

9. The system of claim 1 wherein the celebrity portal is adapted to be displayed on a mobile device.

10. A method comprising:
managing a celebrity portal, the celebrity portal including media content based on real-time multimedia content generated by a particular celebrity and available for consumption by fans;
receiving notice of a scheduled presentation of premium content on the celebrity portal;
notifying a set of the fans of the scheduled presentation of the premium content on the celebrity portal; and
publishing the premium content in the celebrity portal.

11. The method of claim 10 wherein notifying the set of the fans comprises using multiple contact methods.

12. The method of claim 10 wherein the premium content includes at least a portion of the real-time multimedia content.

13. The method of claim 10 wherein the premium content comprises pay-per-view content.

14. The method of claim 10 further comprising providing the set of fans with a timer configured count down to the premium content.

15. The method of claim 14 further comprising providing an expiration notification of the timer a predetermined time before expiration of the timer.

16. The method of claim 10 further comprising selecting at least a portion of the set of fans to view the premium content based on access rights of the least a portion of the set of fans.

17. The method of claim 16 further comprising offering the set of fans an option to purchase the premium content.

18. The method of claim 10 wherein the celebrity portal is adapted to be displayed on a mobile device.

19. A celebrity portal system comprising:
means for managing a celebrity portal, the celebrity portal including media content based on real-time multimedia content generated by a particular celebrity and available for consumption by fans;
means for receiving notice of a scheduled presentation of premium content on the celebrity portal;
means for notifying a set of the fans of the scheduled presentation of the premium content on the celebrity portal; and
means for publishing the premium content in the celebrity portal.
